(19) United States
(12) Patent Application Publication
(10) Pub. No.: US 2020/0151356 A1
(43) Pub. Date: May 14, 2020

(54) SYSTEM AND METHOD FOR FAST AND EFFICIENT SEARCHING OF ENCRYPTED CIPHERTEXTS

(71) Applicant: Duality Technologies, Inc., Maplewood, NJ (US)

(72) Inventors: Kurt ROHLOFF, West Orange, NJ (US); Vinod VAIKUNTANATHAN, Boston, MA (US); Arina SHAINSKI, Ramat Hasharon (IL); Shafi GOLDWASSER, Cambridge, MA (US)

(73) Assignee: Duality Technologies, Inc., Maplewood, NJ (US)

(21) Appl. No.: 16/102,017

(22) Filed: Aug. 13, 2018

Related U.S. Application Data
(60) Provisional application No. 62/544,190, filed on Aug. 11, 2017.

(51) Int. Cl. G06F 21/62; H04L 9/00

(52) U.S. Cl. CPC G06F 21/6227; H04L 9/008

(57) ABSTRACT

An encryption and cryptosystem for fast and efficient searching of ciphertexts. Unencrypted secret data may be transformed into encoded secret data using an injective encoding such that each distinct value of the unencrypted secret data is mapped to a unique index in the encoded secret data. The encoded secret data may be homomorphically encrypted using the homomorphic encryption key to generate secret data ciphertexts. The secret data ciphertexts may be transmitted to an external system for searching the secret data ciphertexts for encoded queries. The encoded queries are encoded by the same injective encoding as the secret data, to directly search only indices of the secret data ciphertexts corresponding to query indices having non-zero query values, to detect if values of the secret data ciphertexts match values of the encoded queries at the query indices, without searching the remaining indices of the secret data ciphertexts.

### CROSS-REFERENCE TO RELATED APPLICATIONS

This application claims the benefit of U.S. Provisional Application Ser. No. 62/544,190, filed Aug. 11, 2017, which is hereby incorporated by reference in its entirety.

### FIELD OF THE INVENTION

Embodiments of the invention are directed to data privacy, security, and encryption of secret data. Embodiments of the invention include systems and methods to encrypt secret data to safely share them with an external or third party, which can then execute queries, searches, or other computations, only on the encrypted secure data, without exposing the underlining secret data.

### BACKGROUND OF THE INVENTION

Today, massive amounts of data live in many organizations, with barriers between them, erected by mistrust, economic incentives and regulatory hurdles. When secret data, such as, personal or medical data is involved, privacy becomes a major concern for all parties involved, as that information can be used to identify or exploit the individuals.

To encourage collaboration, while still protecting data secrecy, crypto systems have been developed that allow parties to operate on encrypted data (i.e., ciphertexts) in an encrypted domain:

Fully Homomorphic Encryption (FHE) cryptosystems allow a third party to evaluate any computation on encrypted data without learning anything about it, such that only the legitimate recipient of the homomorphic calculation will be able to decrypt it using the recipient's secret key. Although FHE can theoretically work on any data, practically, FHE is unrealistic to use in most real-world settings, especially when large amounts of data and complex computations are involved.

Functional Encryption (FE) crypto systems allow authorized third parties who cannot decrypt, to evaluate selective authorized computations on encrypted data, without decrypting first. Such authorized third parties receive a different secret key for each computation, which enables the calculation of the computation on the data without decryption. In secret-key functional encryption schemes, both decryption and encryption require knowing a secret-key. In public-key functional encryption, decryption requires knowing a secret key, whereas encryption can be performed without knowing a secret-key and does not compromise security.

Proxy re-encryption (PRE) cryptosystems transform data encrypted in one key to data encrypted in another key. PRE may be used in settings involving two or more parties each holding a secret key to a different encryption scheme, and for classical encryption schemes.

However, these crypto systems are often inefficient, adding extra layers of computations. Further, because the data being operated on is encrypted, it is difficult to find and target specific data. Current operations to search for specific data are often performed across an entire encrypted data set, which becomes prohibitively inefficient, especially when the datasets are large.

Accordingly, there is a need in the art for a fast and efficient technique to search for and target specific data within a ciphertext in the encrypted domain.

### SUMMARY OF EMBODIMENTS OF THE INVENTION

To overcome the aforementioned limitations inherent in the art, embodiment of the invention may provide a fast and efficient targeted search of ciphertexts in the encrypted domain. Directly searching specific targeted portions or locations within ciphertexts significantly speeds-up searches in the encrypted domain as compared to “blind searches” through entire ciphertexts, particularly as the volume of the ciphertexts grow.

In an embodiment of the invention, a device, system and method is provided for generating an efficiently searchable encryption of secret data. Unencrypted secret data may be transformed into encoded secret data using an injective encoding such that each distinct value of the unencrypted secret data is mapped to a unique index in the encoded secret data. The encoded secret data may be homomorphically encrypted using the homomorphic encryption key to generate one or more secret data ciphertexts, wherein the homomorphic encryption key preserves the indexing of the injective encoding of the secret data. The one or more secret data ciphertexts may be transmitted to an external system for searching the secret data ciphertexts for one or more encoded queries, wherein the one or more encoded queries are encoded by the same injective encoding as the secret data, to directly search only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts.

In an embodiment of the invention, a device, system and method is provided for efficiently searching for one or more queries in an encrypted secret data ciphertext. The queries may be transformed into one or more encoded queries using an injective encoding such that each distinct value of the unencrypted queries is mapped to a unique index in the one or more encoded queries. One or more secret data ciphertexts may be received, from an external encryption system, that represent a homomorphic encryption of secret data using a homomorphic encryption key, wherein the secret data ciphertexts are encoded by the same injective encoding as the one or more encoded queries. The secret data ciphertexts may be searched for the one or more encoded queries by directly searching only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a multi-party system and workflow for fast and efficient targeted searching of ciphertexts in the encrypted domain, according to an embodiment of the invention;

FIG. 2 is a schematic illustration of a multi-party system comprising a single party providing data to one or more external parties, according to an embodiment of the invention;

FIG. 3 is a schematic illustration of a multi-party system comprising a collaboration among multiple data providers, according to an embodiment of the invention; and

FIG. 4 is a schematic illustration of a system operating according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

A system, device, and method is provided for fast and efficient targeted searching of ciphertexts in the encrypted domain.

In operation 103, first party device 140 performs an injective (one-to-one) or bijective (one-to-one and onto) encoding of the unencrypted secret data to transform the secret data into encoded secret data. The injective encoding maps or links each distinct value of the unencrypted secret data to a unique index or location in the encoded secret data. The indexing or position of the injective encoding may be defined by a single index indicating each unique position or length along the 1D data structure, two (or more) indices indicating two unique positions in two respective dimensions of the 2D data structure, and/or N (or more) indices indicating each unique position in N-dimensions of the ND data structure. The indexing may be represented explicitly with each value (e.g., as (value, index)) or implicitly by the order of the value in the data structure. The injective encoding may maintain or alter the dimensions of the secret data, for example, reducing dimensions (e.g., converting a matrix into a vector), maintaining the same number of dimensions, or increasing dimensions (e.g., dividing a dimension into multiple dimensions, or adding one or more indexing dimensions).

In some embodiments, the secret data is dynamic and updates or grows over time as new data becomes available. To dynamically encode new secret data, or reorder, replace, combine, or otherwise alter the encoded secret data, some embodiments may index one or more empty placeholder entries (e.g., a string of zeros at the end of an encoded data sequence) that are dynamically filled when new values become available or alterations to the data are made.

Various data structures may be used to represent the unencrypted secret data and/or encoded secret data. In some embodiments, the unencrypted secret data comprises a plurality of N datasets each associated with a plurality of (the same or different) M_{N} values. The unencrypted and/or encoded secret data may be represented by a single or multi-dimensional data structure. The multi-dimensional data structure may be a double-linked list comprising an “outer” list representing the N datasets and an “inner” list representing the M_{N} values associated with each dataset. In a double linked list, the outer list contains N locations or indices, each of which are linked to a different inner list, where the inner lists are of (same or different) lengths M_{N} (or greater). Double linked lists are more compact (e.g., reducing storage usage) and more efficient to update than conventional multi-dimensional data structures such as matrices. For example, in order to update or alter one of the M_{N} secret data values, only the single inner list containing the value is edited, which implicitly updates the linked outer list without directly retrieving, updating, or altering the outer list in any way Similarly, the outer list may be edited, e.g., filling in, adding, deleting, or rearranging values, without retrieving or altering the inner lists in any way. Another multi-dimensional data structure may be a matrix of dimensions equal to N×maximum M_{N} (or greater, e.g., when the M_{N} values are followed by placeholder entries reserved for future added data). A single dimensional data structure may be one or more sequences or vectors of cumulative length Σ_{n∈N}n·Mₙ, or greater (e.g., when placeholder entries are used to reserve indexes for future added data). Other dimensions or data structures may be used.

In operation 105, first party device 140 may divide the encoded secret data into a plurality of smaller sequences or segments. In one embodiment, first party device 140 may divide the segments at fixed lengths or divide between indices corresponding to non-zero query entries to separately search for each distinct query value. In some embodiments, when at least two of the N datasets have different numbers of values M_{N}, and the segments are divided into fixed lengths, the resulting secret data segments have a combination or mixture of data from multiple different ones of the N datasets. In various embodiments, operation 105 may be skipped, may occur at another time in the workflow (e.g., earlier e.g. prior to encoding, or later e.g., after encrypting), or may be integrated into the encoding operation 103 (e.g., indexing by multiple variables (i,j) to sort the secret data into i segments of same or different length(s) j).

In operation 107, first party device 140 may homomorphically encrypt the encoded secret data using the homomorphic encryption key to generate one or more secret data ciphertexts. The homomorphic encryption key preserves the order of the indexing and injective mapping of the encoding of operation 103, or alters the indexing order in a manner that is bijective or injective to the encoded indexing in operation 103.

In operation 109, first party device 140 transmits the one or more secret data ciphertexts to second party device 150 for searching the secret data ciphertexts with one or more queries in the encrypted domain, without exposing the underlining unencrypted secret data to second party device 150.

In operation 111, second party device 150 stores, retrieves, obtains, and/or generates, one or more encrypted or unencrypted queries. The queries may be represented by any 1D, 2D, . . . , ND data structure and may include one or multiple sets or types of data structures.

In operation 113, second party device 150 performs an injective encoding on the (e.g., encrypted or unencrypted) queries to transform them into one or more encoded queries, such that each distinct value of the input queries is mapped to a unique index in the encoded queries. The injective encoding of operation 113 may be the same as, equivalent to, bijective to, or injective to, the encoding in operation 103 for corresponding values of the query and secret data values. That is, the unique indexing in operations 103 and 113 provides a one-to-one (injective) correspondence between values in the one or more encoded queries and values in the one or more secret data ciphertexts.

In some embodiments, multiple different homomorphic encryption keys may be used in operations 103 and 113 to encrypt multiple different secret data ciphertexts and/or queries. In some embodiments, multiple different incompatible encodings are used to encode multiple different secret data ciphertexts and/or multiple different queries in operation(s) 103 and/or 113, respectively. In such embodiments, one or more of the encodings may be converted to a different one of the multiple encodings by permuting values (e.g., injectively or bijectivly) amongst indices, to unify indexing from incompatible encodings.

In operation 115, second party device 150 may divide the encoded queries into a plurality of smaller sequences or segments. In one embodiment, second party device 140 may divide the segments at fixed lengths or divide at indices between non-zero query entries, so that computing pairwise values at indices in operation 121 returns a separate result for each distinct query value. In one example, when the input data includes multiple datasets of different sizes or lengths, and the data is divided into fixed size or length blocks, different segments may have a combination or mixture of data from multiple different datasets. In some embodiments, operation 115 may be skipped, may occur at another time in the workflow (e.g., earlier to segment unencrypted queries or at a later time to segment encrypted query ciphertexts), or may be integrated into the encoding operation 113 (e.g., indexing by multiple variables (i,j) to sort the queries into i segments of same or different length(s) j).

Second party device 150 may search with one or more unencrypted queries or encrypted query ciphertexts. If second party device 150 searches with an unencrypted query, second party device 150 may proceed to operation 121. If second party device 150 searches with encrypted query ciphertexts, second party device 150 may proceed to operation 117.

In operation 117, second party device 150 may encrypt the one or more queries to generate one or more query ciphertexts, encrypted using a copy of the same homomorphic encryption key used to encrypt the secret data ciphertexts in operation 107. The homomorphic encryption key preserves the order of the indexing of the injective encoding in operation 113, or alters the indexing in an injective or bijective manner.

In operation 119, second party device 150 may receive, from first party device 140, the one or more secret data ciphertexts generated in operation 107.

In operation 121, second party device 150 may search the secret data ciphertexts for the one or more (encrypted or unencrypted) encoded queries by searching only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts. Selectively searching certain indices of the secret data (and not other indices) may be achieved by operating on the secret data ciphertexts by non-zero values at those searched indices (and operating on the secret data ciphertexts by zero values at the remaining non-searched indices, thereby deleting or ignoring their values). For example, a ciphertext may be e.g., (010000101011001010000010100 . . . ) and a query may be e.g., (1100000000000000000000000 . . . ) to search for a first and second values. In some embodiments, a search operation may be a homomorphic pairwise product of cyphertext and query values at each index. For example, the search operation may be a homomorphic pairwise vector product of the cyphertext and query e.g., (0100000000000000000000000 . . . ) or may be an inner product of the cyphertext and query resulting in a scalar value e.g., (1). Because the query only has two non-zero values, the search operation only evaluates or searches for those first two values of the ciphertext, ignoring or zero-ing all the remaining indices thereafter. The inner product in the example above returns a search result (e.g., 1) indicating the number of query fields found in the secret data, while the vector product preserves indexing to indicate exactly which field (e.g., the second field) was found in the secret data. The inner product may also specify which particular field is found in the search when searching for one field at a time. The remaining fields are ignored or zero-ed by the search operation. Alternatively or additionally, the search operation may be a homomorphic multiplication (e.g., dot product of) one or more pairs of the encoded query and secret data ciphertext values at one or more respective indices, which may be merged or combined (e.g., rotating or permuting the result to a common (e.g., first) index), and then homomorphically added. In embodiments where the queries are encrypted, since the non-zero indices are unknown, the merging or rotating may be applied to combine all indices. In embodiments where the queries are unencrypted, the non-zero indices are known, and only that subset of non-zero indices may be merged or rotated and combined.

Second party device 150 may detect a match when the homomorphic search operation results in a non-zero value and a mismatch when the homomorphic search operation results in a zero value (although other equivalent measures, such as positive vs. negative, or above vs. below threshold, may also be used to differentiate a match and mismatch). In some embodiments, each value match contributes a set non-zero value (e.g., 1) to the result, so that the cumulative result may be used to determine the total number of query value matches in the secret data search. For example, computing a zero value indicates no match, computing a first value (e.g., one) indicates a single match, and computing a multiple m of the first value indicates a plurality of m matches between values of the queries and secret data ciphertexts. Further, if there are multiple distinct queries, second party device 150 may sum multiple results of searching for the multiple distinct queries in the secret data ciphertexts to get a total cumulative number of detected query matches.

In one application, the secret data in operation 101 may comprises genomic data obtained by sequencing DNA at a genomic sequencer, e.g., as described in further detail below. In some embodiments, the unencrypted secret genomic data may be represented by N datasets each associated with one or more DNA locations or genetic conditions. Each of the N datasets may include a plurality of M_{N} values e.g., representing M_{N} genetic mutations respectively associated with the N DNA locations or genetic conditions. The search in operation 121 may detect if a query mutation is present in a patient's DNA sequence, without exposing the patient's unencrypted DNA sequence to the search system.

Additionally or alternatively to searching, second party device 150 may perform any computation targeting a subset of values of the secret data by selectively operating on those using non-zero operator values, and ignoring the remaining data using zero operator values, at corresponding indices.

After operation 121, the encrypted secret search or computational results may be stored or transmitted from second party device 150 to first party device 140, where first party device 140 may decrypt and generate an unencrypted version of the search or computational results in the unencrypted domain.

Other operations or orders of operations may be used.

### Genomics Application

Embodiments of the invention are directed to the privacy, security, and encryption of secret data. One use of such embodiments is in the field of bioinformatics, and in particular, the field of Genomics. Genomic or genetic data requires privacy for regulatory compliance. In today's world, massive amounts of genomic data are stored across many organizations, which cannot collaborate or share data because of privacy and regulations. Embodiments of the invention aim to break these walls and extract utility from genomic information without compromising and even enhancing security.

Embodiments of the invention provide a host of techniques, which together form a platform to address many of the privacy concerns which arise throughout the storage and processing of genomic, biological and medical information, while allowing flexible flow and distribution of the information. While some embodiments are described in reference to genomic applications, this is only an example of an environment that requires data privacy, and other applications may also be used.

Embodiments of the invention include systems and methods for protecting not only the data, but additionally or alternatively, protecting the details of the computations (e.g., an ordered sequence of calculations) which are performed by a processor on the data.

Some embodiments of the invention make the use of encryption technology applicable in the genomic, biological and medical setting, allowing various parties to encrypt the sensitive data and computations so that computations can be performed on data ‘in an untrusted or external environment, such as, in the cloud (or in any other possibly insecure facility), in an efficient and secure manner.

Some embodiments of the invention may comprise one or more of the following parts:
1. A particularly efficient data representation e.g., for genomic, biological and medical information suitable for use by encryption methods, which enable a plurality of efficient operations on encrypted data.
2. A plurality of key management models and implementations suitable for storage of keys and encrypted data at multiple sites, transfer of keys and encrypted data between multiple parties, and processing of e.g., encrypted genomic, biological and medical data, using different encryption algorithms and different keys.
3. Methods for encrypting a plurality of computations, so that a remote server that has access to the encrypted computations can execute them on encrypted (and unencrypted) data. Particularly efficient methods for specific computations e.g., over genomic, biological and medical data are proposed. These methods are compatible with any data representations and any key management model. Embodiments of data representation, encryption schemes, and key management models are disclosed that enable particularly efficient implementations.
4. Token-based models for outsourcing encrypted (or garbled) computation on private (and non-private) data are introduced. These encrypted (or garbled) computations can be executed over any type of data and e.g., over genomic, biological and medical data represented in a plurality of ways. Embodiments of the invention provide a particular scheme for linear computations. Such methods enable private and proprietary programs to be outsourced to untrusted computation hosts. Whenever the hosts are given in addition digital tokens for the data, the outsourced programs can be executed on said data.

Each of the above parts of embodiments of the invention is elaborated on as follows.

1) Fully Homomorphic Encryption (FHE) cryptosystems allow a third party to evaluate any computation on encrypted data without decrypting or learning anything about the encrypted data. FHE computations however are complex and cumbersome, especially when large amounts of data and complex computations are involved. Genomic data possesses unique challenges in both of these aspects.

Embodiments of the invention provide a novel approach to handle genomic data, making genomic data suitable for efficient FHE computations. Embodiments of the invention also support multiparty computations via multi-key FHE, enabling computations on inputs that are encrypted under multiple different keys such that the result can be decrypted only by joint collaboration of all involved parties which have access to the corresponding different secret keys.

2) As many entities are involved in most use cases concerning biological or medical data (e.g. patients, health providers, researchers, sequencing centers, pharmaceuticals), each with its own keys, embodiments of the invention may allow the encrypted data to be transferred between entities while staying protected and FHE suitable.

Embodiments of the invention provide a powerful key management model that allows flexible flow and distribution of genomic, biological and medical data between the involved parties. Embodiments of the invention are compatible with the Proxy Re-Encryption technology that allows efficient and secure conversion of FHE ciphertexts from one party to another on-the-fly, for example, as disclosed in U.S. Patent Application Publication No. 2017/0155628, filed Dec. 1, 2016, entitled “Device, System and Method for Fast and Secure Proxy Re-Encryption,” which is incorporated in its entirety herein by reference. Embodiments of the invention ensure that each party obtains only the exact pieces of information it is authorized to get, and only after explicit approval of the data's owner(s). Combined with FHE evaluations, such embodiments allow accurate delegation of information between the various parties (e.g., patients, health providers, researchers, sequencing centers, pharmaceuticals), so that each party can transfer only the exact result of a computation on its data, without sharing the raw data itself. For example, a positive or negative result of some genetic test exposes less information than the underlying genotype of all the variants and genes involved in that test, and thus is superior for preserving privacy.

3) In many use cases in the genomic and biological arena, not only does the data provider (e.g., patient, sequence generator) have privacy concerns, but the provider of the computation to be performed over the genomic or biological data (e.g., pharmaceuticals, research labs) may also have security concerns. Hiding the details of the computation becomes crucial. This is often referred to as code obfuscation or code garbling. For example, pharmaceutical companies may want to keep their genetic tests a secret, and even charge money for using them. A framework that allows the calculation of their tests by a third party without exposing the details of the test itself can allow them to keep their tests secret.

In another example, code obfuscation may be used for genomic data for research purposes. A researcher conducting a genomic study may not want the other parties (including those owning the data she is analyzing) to learn the exact details of her conducted study. That's especially common when commercial companies, like pharmaceuticals, play the role of the researcher. They may be interested in testing some hypotheses on external data, but clearly uninterested in disclosing what exactly they are testing for, as their hypotheses could potentially be secret too. If a pharmaceutical company suspects that certain variants are associated with a certain disease, the company may not want to expose what variants or what phenotypes are being investigated.

In yet another example, code obfuscation may be used by researchers who want to obtain statistics from a database containing sensitive information such as medical, biological or genomic records. In this case, one may think of the computation as providing query-access to the private database and the query as providing the input to the computation.

Embodiments of the invention provide methods for obfuscating (or garbling) computations over genomic data. Such methods may (but are not restricted to) use FHE techniques in a way that is efficient and compatible to the data representation and key management model. When both computation and data need to be hidden, embodiments of the invention may use multi-key FHE techniques in a way that is efficient and compatible to the data representation and key management model.

4) Embodiments of the invention provide a token-based obfuscation model in which computations on secret data, such as, biological, medical and genomic data, are obfuscated (or garbled) so that the obfuscated computation can be stored in the cloud (or anywhere else) without disclosing the original computation. In a token-based obfuscation model, computation can be performed on data only given a digital token for the data, which constitutes an authorization for performing the test on the data. Embodiments of the invention show implementations of the token-based obfuscation model for general computations.

Finally, for linear functions, embodiments of the invention provide a special particularly efficient token-based scheme, wherein a user (or an agent acting on behalf of a user) encrypts genomic data and stores it on a server, and the user can later issue “tokens” for linear functions that allow the server to compute these functions on the encrypted data and obtain the result of the linear functions on the data. The new token generation algorithm run-time is logarithmic in the number of summands of the linear function.

Embodiments of the invention provide a novel approach to handle large amounts of data and/or complex computations, making it suitable for efficient FHE computations. Embodiments of the invention also support multiparty computations via multi-key FHE. Multi-key FHE enables computation on inputs that are encrypted under different keys, such that the result can be decrypted only by joint collaboration of all involved parties.

Embodiments of the invention provide a key management model that allows flexible flow and distribution of e.g., genomic, biological and medical data, between multiple involved parties. Embodiments of the invention may use a Proxy Re-Encryption (PRE) technology especially suited to handle genomic data.

There is now provided a system and method for a sparse data representation of secret data such as genomic, biological and medical information suitable for use by encryption methods, which enable a plurality of efficient operations on encrypted data. A system and method for providing a plurality of key management models and implementations suitable for storage of keys and encrypted data at multiple sites, transfer of keys and encrypted data between multiple parties, and processing of encrypted genomic, biological and medical data, using different encryption algorithms and different keys. A system and method for encrypting a plurality of computations, so that a remote server that has access to the encrypted computations can execute them on encrypted (and unencrypted) data. A system and method for providing token-based models for outsourcing encrypted computation.

### Setup

In this section, typical parties involved in genomic, biological or medical settings and their typical security concerns are discussed.

### Involved Parties

Data provider: A party providing its genomic, biological or medical data for secure computations. For example, a patient may want to use his genomic data to perform a disease risk calculation and send the results to his care provider. The data provider may also be an organization. For example, a hospital with thousands of sequenced genomes (of different individuals) may want to use its database for secure computations using our platform.

Care provider: A patient's care provider (e.g. hospital, doctor or genetic counselor) is often the party initiating some calculation on the patient's data, and is often the party that gets the results. For example, a patient's doctor may ask him to perform a genetic test for disease risk.

Test provider: Tests and algorithms to analyze genomic, medical or biological data are often created by test providers. For example, molecular diagnostic companies may provide genetic tests for disease risk.

Data generator: A lab or institution generating data based on biological samples. The data provider, in this case, may be the party providing the samples, and not the data generator. For example, a sequencing center may provide genomic data based on individuals' samples.

Researcher: Data providers may decide to share their data for research purposes. A researcher may be any individual or organization interested in conducting genomic, biological or medical studies.

Computation host: The server making secure computations on behalf of other parties. These computations may be executed on the cloud or other dedicated servers.

Other trusted servers: Occasionally the other parties may choose to delegate sensitive tasks to other trusted servers, other than the computation host. For example, a separate PRE server can be used (as discussed below).

It should be noted that although all these parties are described as separate entities, in various use cases the same entity can take the role of several parties, or several entities can take the role of a single party. For example, the care provider (e.g., hospital) may also be the test provider or the data generator. When computations are obfuscated, the data provider may also take the role of the computation host by securely running an encrypted research computation on its data.

### Security Concerns of the Parties

Data provider: Keeping its data private, sharing parts of its data (or computational results thereof) with other parties, for example, only by explicit cryptographically-enforced consent.

Care provider: Interested in keeping the data private for the security of its patients.

Test provider: A test provider may want to keep some of its algorithms a secret. It typically wants to allow other parties to use its algorithms on specific inputs and get the computation results, but, sometimes, without exposing the computations themselves, and only after approving their use.

Data generator: Interested in keeping the data private for the security of its customers.

Researcher: A research entity may care about privacy as well, wishing to conceal the details of the study it's conducting. For example, a pharmaceutical company may look to find new target candidates for a therapy it's developing. It may suspect that several genes are involved in a disease's pathways that it's trying to affect, looking to test its hypothesis using other parties' data, but the company may not want anyone to know which genes it's looking at, as leakage of such information could compromise the secrecy of the study.

Computation host: The computation host is typically responsible for meeting the security concerns of all other parties. The sensitive data of other parties may be protected not only from malicious entities in the external world, but also from the computation host itself and all of its employees, who may be honest, but curious (meaning that an employee does what it is supposed to do, but may occasionally leak information). Henceforth we shall relate to it as the “honest-but-curious model”. The computation host wants to make it impossible for itself to violate the privacy of the other parties, thus making them feel safer and prevent undesirable incidents.

Other trusted servers: Trusted servers are expected to protect the data and communication they share with the other parties.

### Preliminaries

### The BGV, BFV and LTV Scheme

Although other FHE schemes could be used with embodiments of the invention, the FHE scheme which is based on the well-known Brakerski-Gentry-Vaikuntanthan (BGV), Brakerski-Fan-Vercauteren (BFV) and Lopez-Tromer-Vaikuntanathan (LTV) cryptosystems seem to be most suitable for the task, due to its high efficiency and other properties described herein.

Ciphertexts in the LTV scheme are polynomials in the ring of integers of a number field. In particular, let φ(x) be a degree-n univariate polynomial with integer coefficients, and let q be a rational integer. [symbol] [x] denotes the set of polynomials with integer coefficients, R:= [symbol] [x]/φ(x) denotes the set of such polynomials where multiplication is performed modulo φ(x), and R_{q}:= [symbol] _{q}[x]/φ(x) denotes the set of such polynomials modulo φ(x) and q. The number q may be referred to herein as the “ciphertext modulus”, and has significance on the security of the protocol, the depth of circuits that can be evaluated without bootstrapping, and the size of the ciphertexts.

A vector of plaintexts M₀, M₁, . . . , Mₙ₋₁ may be converted into a polynomial m in the ring R_{q}, in several ways. A simple way is to create the polynomial m to be such that its coefficients are exactly the M₀, M₁, . . . , Mₙ₋₁—this is called coefficient embedding. A more expressive way to create the polynomial m is called the evaluation embedding or canonical embedding which is described in more detail below.

Once the plaintext is transformed into the polynomial m in one of these two ways, it is encrypted as a ciphertext c=hs+pe+m, where p<q is a parameter number called the “plaintext modulus”, s and e are noise polynomials, and h=pgf⁻¹ is the public key (also a polynomial). In order to decrypt c and recover the plaintext m, it may be multiplied by the secret key f and taken modulo p. Assuming that the coefficients in m are smaller than the plaintext modulus p, and that the amount of noise in the ciphertext is not too high with respect to the ciphertext modulus q, this decryption procedure will give the same plaintext m we have started with.

BGV, BFV and LTV are fully homomorphic, meaning that in addition to key generation, encryption and decryption algorithms, it also implements evaluation algorithms that, given evaluation keys, can calculate any circuit over ciphertexts, outputting a result ciphertext. The result ciphertext decrypts into the same plaintext that would be obtained by evaluating this circuit over the input plaintexts. Specifically it implements the addition and multiplication circuits (that are equivalent to XOR and AND when binary values are involved), which are sufficient to implement all possible circuits.

In addition, BGV, BFV and LTV allows on-the-fly multiparty computations, namely FHE evaluating not only on ciphertexts encrypted under the same key, but also on ciphertexts encrypted under different keys of different parties, obtaining a ciphertext result encrypted by multiple layers of encryption that can be decrypted only by mutual collaboration of all parties involved (using their secret keys). It also allows Proxy Re-Encryption to delegate data between parties (as described later in the document).

### SIMD in the BGV, BFV and LTV Scheme

Single Instruction Multiple Data (SIMD) is an optimization that allows the same operation to be performed on multiple data points simultaneously using a vectorial representation of the data. The BGV, BFV and LTV scheme can be extended to support SIMD by allowing each plaintext polynomial of degree n−1 (which is represented by n integer coefficients) to encode n units of information in a special way. Without support for multiplicative homomorphism, this may be achieved using the coefficient embedding of plaintexts as described above. However, the key trick is in encoding a vector of messages while allowing a SIMD multiplicative homomorphic operation on them. This will require us to slightly revisit the description of the BGV, BFV and LTV scheme described above.

One implementation of using SIMD in an LTV scheme may proceed as follows. A plaintext modulus p may be selected such that the ring [symbol] ₚ[x]/φ(x) decomposes completely. That is, the polynomial φ(x) can be written as the product of linear factors (x−ξᵢ) modulo p. ξᵢ may be referred to herein as the “roots of unity”. The computations may be conducted using a ring of dimension n and with n values of data (smaller than the plaintext modulus p), m=(m₁, . . . , mₙ), that is to be encrypted into a single ciphertext. Then, to encode the vector of messages m, a polynomial μ may be calculated satisfying: ∀i∈[n]: μ(ξᵢ)=mᵢ (mod p). This can be done in n·log(n) complexity using Fast Fourier Transforms (FFT). This polynomial may then be encrypted into the ciphertext c=hs+pe+μ, which will be the encryption of the message m. In order to decrypt it, the ciphertext may be multiplied by the secret key f to get: mᵢ=(fc)(ξᵢ) (mod p). This representation allows easy FHE evaluation in SIMD fashion, as c₁+c₂ would now decrypt to (m₁¹+m₁², . . . , mₙ¹+mₙ²), and c₁c₂ would decrypt to (m₁¹m₁², . . . , mₙ¹mₙ²).

Under this representation the ring dimension n both influences the strength of the encryption and determines the number of bits or integers encrypted (and evaluated in each SIMD operation) in each ciphertext.

### Basic Evaluations

Embodiments of the invention provide systems and methods for performing basic computations that can be evaluated in the BGV, BFV and LTV scheme (e.g., evaluated by another party with access to the public and evaluation keys, but not to the secret key).

### Extracting a Single Value

Let c be a ciphertext in the SIMD representation described above that decrypts to a message m=(m₁, . . . , mₙ), and let i∈[n]. Embodiments of the invention aim to find a new ciphertext c′ that decrypts to (mᵢ, 0, . . . ,0).

The parameters may be chosen such that p,q≡1 (mod 2n) and n is a power of 2. Furthermore, ξ:=ξ₁ may be a generator of a subgroup of order 2n of the Euler group [symbol] *ₚ. Such a subgroup exists because 2n divides p−1. For every i∈[n], we set ξᵢ=ξ²ⁱ⁻¹. Automorphisms ψᵢ,ψᵢ⁻¹ may be defined over Rₚ by ψᵢ(x):=x²ⁱ⁻¹ and ψᵢ⁻¹(x):x^{t} for an integer t<2n satisfying t(2i−1)≡1 (mod 2n) (such an integer exists because gcd(2i−1,2n)=1). Then indeed: ψᵢ⁻¹(ξᵢ)=(ξ²ⁱ⁻¹)^{t}=ξ(mod p), since t(2i−1) (mod 2n).

An algorithm to extract a single value from a ciphertext may proceeds as follows.
1) Compute a homomorphic AND with a proper mask to obtain a new ciphertext ĉ that decrypts to (0, . . . ,0, mᵢ, 0, . . . ,0).
2) Apply the automorphism ψᵢ⁻¹ to the ciphertext. This will change ĉ into a new ciphertext ĉ that encrypts the sequences of messages (m₁, 0, . . . ,0) under a different key pair (\tilde{f}, \tilde{h}) rather than (f, h), where the polynomials (\tilde{f}, \tilde{h}) are obtained from (f,h) by applying the automorphism ψᵢ⁻¹. We note that in order to apply the automorphism to the ciphertext, one does not need to know the secret key f. This gives us a ciphertext \tilde{c} that decrypts to (m₁, 0, . . . ,0) by \tilde{f}, meaning that (\tilde{f}\tilde{c})(ξ₁)=mᵢ (mod p), and that (\tilde{f}\tilde{c})(ξⱼ)=0 (mod p) for every j≠1.
3) Finally, a key switching operation is performed over the ciphertext \tilde{c} to obtain a ciphertext c′ that encrypts (mᵢ, 0, . . . ,0) by f. This operation uses key switching parameters published as part of the public key. The key switching parameters include, roughly speaking, an encryption of the modified secret key \tilde{f} under the original public key h.

### NOT Operator

The NOT operator operates over binary values, for example, in {0,1}, sending 0 to 1 and vice versa (since the input is binary, the operator's behavior on other integers is irrelevant). In order to evaluate the NOT operator on a ciphertext with any plaintext modulus p, the operation x→1−x may be evaluated over the values of the ciphertext, which can be done in SIMD fashion as (f(1−c))(ξᵢ)=(f) )ξᵢ)−(f c))ξᵢ)=1−mᵢ (mod p) where 1 is the encryption of the all-ones vector under the same key.

### OR Operator

In order to calculate the OR operator over k binary values (ν₁, . . . , νₖ), the fact may be used that ν₁∨ . . . ∨νₖ=¬(¬ν₁∧ . . . ∧¬νₖ) where ∨, ∧ and ¬ are the OR, AND and NOT operators, respectively. Hence evaluating the OR operator for k values simply requires evaluating the product of k values, which can be done with log k levels of multiplications when aggregating the values hierarchically.

This method gives the exact result, 0 or 1, and can later be fed into further computations evaluated homomorphically. If, however, the result of the OR operator shouldn't be further used in evaluations, but rather returned as a final result to some recipient for decryption, there is a more efficient way to execute OR operations (in terms of levels of multiplications, which increases the noise most dramatically and therefore costs in efficiency the most).

This alternative method of executing OR operations may proceed as follows. Let w₁, . . . , wₖ∈[p−1] be random integers modulo p. Then the weighted sum r:=w₁ν₁+ . . . +wₖνₖ (mod p) will give a random number in [symbol] ₚ if any of νᵢ are not 1, but will surely give 0 when νᵢ=0 for every i. In other words, this weighted sum allows us to know the value of ν₁∨ . . . ∨νₖ (but nothing else about these values) with a probability of (p−1)/p. By repeating this process multiple times with different random weights every time, one could easily increase the probability enough to be a limit approaching 1 (the difference from 1 being a tunable parameter associated with an acceptably small error). By sending the recipient an evaluation of multiple random weighted sums over the binary values, the recipient may be able to decrypt the given ciphertexts and know the correct result. It may be noted that calculating the weighted sum does not require any ciphertext multiplications, only one level of multiplication with clear numbers and additions.

### Binarization

Let ν∈ [symbol] ₚ be an integer. Embodiments of the invention aim to calculate a binary value b=ν^{p-1} mod p), which will be 0 only if ν is also 0 and will be 1 if ν is any value other than 0. When evaluating this homomorphically, this calculation may require a relatively high number of multiplications (which are computationally costly). Similarly to what was done with OR evaluation, the computation of ν can be dramatically improved when the binarization b is the final result that has to be sent to the recipient (i.e. only the binary value b is calculated, whether ν is equal or different than 0, but not the exact value of ν). Again, ν is multiplied by a random number, and this process is repeated multiple times, for example, until the probability of the correct value approaches 1.

### String Comparison

Let a=(a₁, . . . , aₖ) and b=(b₁, . . . , bₖ) be two binary vectors. Embodiments of the invention aim to calculate whether the two vectors are equal to each other, namely returning 1 or 0 dependent on whether ∀i∉[k]: aᵢ=bᵢ or not, respectively. As a first step, a new vector ν=(ν₁, . . . , νₖ) may be calculated given by νᵢ=1−(aᵢ−bᵢ)². Since aᵢ and bᵢ are binary, this will give 1 when they are equal (aᵢ=bᵢ) and 0 otherwise (aᵢ≠bᵢ). When p=2 this calculation can be further simplified by removing the square calculation (since −1=1 (mod 2)), to give νᵢ=1−(aᵢ−bᵢ)(mod 2). Now the evaluation of this string comparison can be reduced to the evaluation of the AND operator over the elements of ν, which can be done with log k levels of multiplications.

Again, when the string comparison is the final result to be evaluated, embodiments of the invention can use the same trick demonstrated for the OR operator. By using the fact that ν₁ ∧ . . . ∧νₖ=¬(¬ν₁∨ . . . ∨¬νₖ), this can be reduced to evaluating an OR using the efficient method described above.

Embodiments of the invention further includes a new method to speed up the string comparison, and more generally the AND of many bits, described in more detail below.

### Secret Key Functional Encryption

A secret-key functional encryption scheme SFE for a class of functions F may be a tuple of four algorithms (SFE.Setup, SFE.KeyGen, SFE.Enc, SFE.Dec) such that:

SFE.Setup inputs the security parameter and outputs a master secret key “msk”.

SFE.KeyGen inputs the master secret key msk and a description of a function f in F and outputs a key “skf”.

SFE.Enc inputs the master secret key msk and an input D and outputs a ciphertext “c”.

SFE.Dec inputs a key sk and a ciphertext c and outputs a value y such that y=D when both c=SFE.Enc(msk,D) and sk=msk; and y=f(D) when both c=SFE.Enc(msk,D) and sk=SFE.KeyGen(msk,f).

Function encryption may be used to build token-based genomics schemes as will be discussed more below.

### Data Representation and Computation on Ciphertexts

### Types of Data

Embodiments of the invention allows data providers to securely store, manage and perform computations over their data, and for other parties (e.g., test providers and researchers) to securely make computations on their or other parties' data. This section describes examples of data for which embodiments of the invention may be used. However, embodiments of the invention may also be used with other types of secret or private data.

1. Genomic Data

One important objective of embodiments of the invention is to allow secure storage, management and calculation over genomic data.

2. Phenotypic Data

Embodiments of the invention also support the handling of phenotypic data, namely any trait of individuals that has biological or medical significance. This data can be used for a patient's direct benefit in certain use-cases (e.g., when calculating the risk for a certain disease, which may depend on other factors other than genotype) or for research purposes (which can also, indirectly, benefit the patient). The ability to conduct association studies may depend on the richness and completeness of the collected phenotypic data, in addition to the availability of genomic data.

3. Meta-Data

Other types of data, that are not strictly phenotypic, can also be relevant in some use cases. For example, a date of birth might be useful in order to derive a patient's age, which is often an important factor for disease risk. Gender may also be important (although it can be recovered from the genomic data). Some of these fields should be encrypted, while other low-security or insensitive fields may remain unencrypted.

4. Expression Data

“Gene expression” may refer to measures of RNA levels in cells, which is sometimes used in clinics in addition to sequencing (e.g., for cancer).

5. Other Biological Data

In addition to sequencing and expression analysis, there are other technologies that collect massive amounts of data, for which privacy and security are also a concern. These include: proteomics, epigenomics, metabolomics and microbiomics.

### Data Encoding

Some embodiments of the invention may encode the types of data described above as plaintexts, using a representation that may later be convenient to encrypt and handle as ciphertexts.

Many forms of data representations are possible for plaintext data so that the data can be encrypted with plain encryption schemes (such as the Advanced Encryption Standard (AES)), FHE, multi-key FHE, or FE techniques.

However, in order to enable particularly efficient evaluations of computations on FHE and FE ciphertexts, embodiments of the invention propose particular data representations for genomic, phenotypic and expression data (respectively) which the parties can use to achieve better efficiency.

### How to Encode Genomic Data

In order to store an individual's genomic data, embodiments of the invention may only keep track of the individual's variants (e.g., all the differences between the individual's genome to some reference genome, such as, GRCh37). Many or most of these variants are Single Nucleotide Polymorphisms (SNPs; e.g. c.53T>C), which are typically considered to be the most common and important type of variants. Other types of variants include Insertions and deletions (e.g. c.61delA, c.64_65delTT, c.62dupT, c.66_67insC), more complex indels (insertion or deletion of bases) (e.g. c.38_39delATinsGGG), copy number variations (which can often be treated as a special case of insertion), and more. It may not be important to distinguish between the different variant types, and embodiments of the invention may assume that these variants can be named and described unambiguously. Embodiments of the invention may track the following information:

Zygosity—whether a variant is present in both of the alleles (homozygous alternative), only one of them (heterozygous) or none (homozygous reference).

Haplotyping—whether two variants are present in the same or different copies of a chromosome, for example when cis regulatory elements are involved.

In order to keep track of all of these properties, some embodiments of the invention may keep track of the two allele values of each variant (or any other number of copies, depending on the number of homologous chromosomes in that particular genetic locus).

Finally, it may be appreciated that the genomic data obtained from a sequencing procedure is often incomplete, and may produce only a fraction of an individual's genome. For example, exome sequencing procedure should ideally provide a complete image of the variants within the expressed portion of the genome, but typically provides no information about one's introns or intergenic regions.

Even when a part of the genome is included in a sequencing procedure, the information may sometimes be insufficient for certain genotyping of some regions (e.g., there might not be enough reads overlapping the data). Alternatively, embodiments of the invention may provide an estimation of one's genotype in a certain region, for example, only up to a limited probability (p<1). Therefore, it may be important to discriminate between “that person doesn't have this variant,” “we don't know whether that person has this variant,” and “that person doesn't have this variant with 85% probability”.

Embodiments of the invention provide an encoding for genomic or other secret data that is compact, flexible and easy to work with when utilized in the context of homomorphic encryption. First, embodiments of the invention may maintain a public database with all (or many of) the known variants that have ever been catalogued. Then, when a new genome is processed, new discovered variants may be added to this database, for example, in case this new genome has some new variants that were not catalogued or have never before been detected.

Each variant may be represented in the public database, for example, by all data required to unambiguously identify the variant. For example, a variant may include information about its locus in the gnome (e.g., chromosome and position or index within the chromosome), the reference sequence at this locus (e.g., AG) and the alternative sequence caused by this variant (e.g., ATG, in case of T insertion). The variate may also be represented by additional fields to assist other parties in recognizing the variant, for example, a database identifier such as the Single Nucleotide Polymorphism Database (dbSNP) identifier (e.g., rs139112950).

In some embodiments of the invention, each variant may be binary, meaning that each allele can take only two values with respect to the variant; either it has the variant or it doesn't. Variants with more than two options may be broken down to a set of mutually exclusive binary variants.

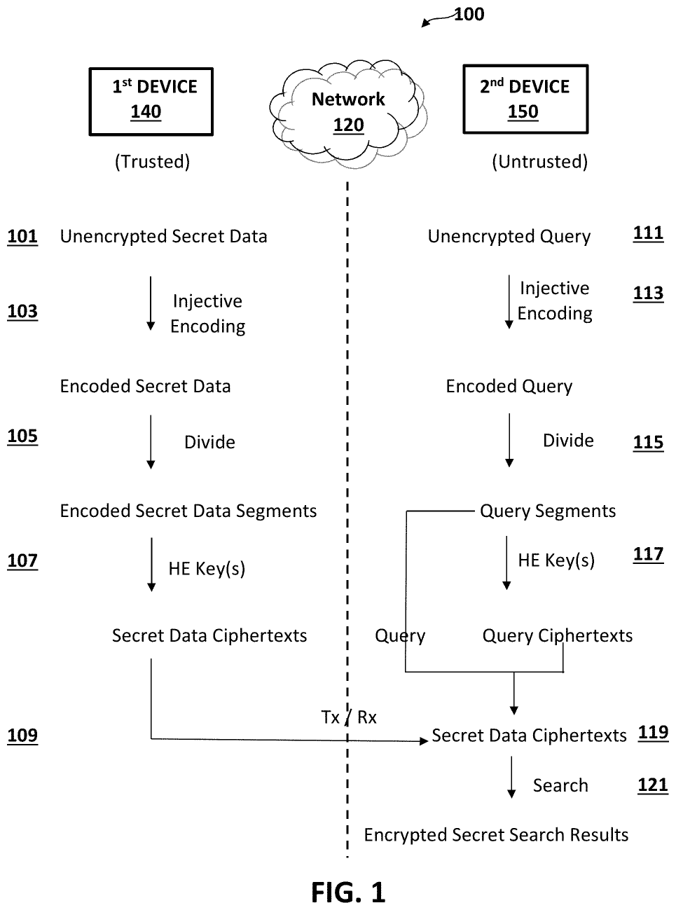

Once there is a public list of binary variants, the entire genomic data of a person or other organism can be represented as the subset of variants present in each of the person's (usually two) copies of chromosomes. Hence, some embodiments of the invention can encode the person's entire genome in the following way. Let V be the set of all variants in the public database, and let c_{ν} be the number of alleles with respect to each variant ν∈V (e.g. usually c_{ν}=2). A may be defined as A:={(ν, i)|ν∈V, i∈[c_{ν}]}, which is the set of all possible alleles. An individual's genome is then described as a mapping g: A→{0,1} describing the value of each allele with respect to the recognized binary variants. By sorting the elements in A deterministically according to some well-defined order, we can encode secret data such as one's genome as a binary vector of length N:=|A| (e.g., as performed in operation 103 of FIG. 1).

Using this encoding, embodiments of the invention may treat the encoded secret genomic data as a binary vector, which can then be encrypted (e.g., as performed in operation 107 of FIG. 1). This representation will also allow embodiments of the invention to keep track of haplotypes and phasing of the variants (e.g. knowing if different variants are on the exact same chromosome, or on different copies of the chromosome). For example, as a convention, i=1 may be defined to refer to a maternal copy of a chromosome and i=2 may be defined to refer to a paternal copy of a chromosome (other conventions may be used). Most of the time, however, the phasing of the data isn't determined by simple sequencing protocols (e.g. as it may use more sophisticated approaches), so the assignment of i∈[cₚ] may be arbitrary. This representation may allow even more sophisticated encodings. For example, the database should not be limited to individual variants, but can also be used to store bigger haplotypes comprised of multiple variants, thus achieving an even more accurate and compact representation of genomic data.

As stated before, representations of genomic data according to embodiments of the invention may be able to indicate that the existence of certain variants is not known, or known only with a limited probability. Therefore, in addition to the vector of data itself, embodiments of the invention may store additional parallel vectors of the same length indicating the confidence level for each of the values in the original data vector. These vectors may indicate a numerical probability for each position, a categorical certainty (e.g. 1 for known variant values, 0 for unknown variant values), or both. Vectors indicating the categorical certainty may be referred to as “certainty mask” vectors, and the value of an allele in the original vector may be meaningful only if the mask indicates 1 at the same position. Embodiments of the invention may refer to this (or another) representation. An example of an alternative approach to handle uncertainty is to encode the values and certainties in the same vector by assigning ternary values (three possible values), quaternary values (four possible values), or n-ary values (any integer number of n possible values), rather than binary values (two possible values), in each position of the encoded secret data. In the example of a ternary representation, each variant may be assigned one of three values, for example, 0, 1 and 2, associated with meanings such as “variant doesn't exist in this allele”, “variant exists in this allele” and “we don't know whether the variant exists in this allele”.

So far, methods have been described for encoding genomic data as Boolean and/or numerical vectors of size N. When a new genome is added to a dataset of genomes encoded in this form, k new variants that have never been encountered before might be present in this genome. Embodiments of the invention may add the k new variants to the public database and update the entire dataset accordingly. This may be done by appending the new variants to the end of the database such that n new alleles (e.g. usually n=2k) added to A (the set of all possible alleles) will appear last in its internal order, meaning that the new values will have to be appended to the end of the existing vectors. Since these variants, by definition, don't appear in any of the existing genomes, n zeros may be appended as placeholder indices to the relevant data vectors, which will then be of size N+n. Other arrangements of appending new alleles may be used, e.g. inserting alleles based on the genetic locus or loci at which they occur.

Representing genomic data as Boolean/numerical vectors may be ideal for encryption and FHE evaluation. This compact representation may refer to the database of all known variants, which may be available to all parties handling the data in its original or encoded forms. Without access to the database, the parties would be unable to assign meaning to the bits and numbers populating the data vectors, and they would not be able to perform any meaningful operation on the encrypted data. A test provider, for example, may need to access the database in order to compile a variant-dependent calculation into a concrete computation that can run homomorphically on genomic data and evaluate an encrypted result. In various embodiments, the database may be fully public (unencrypted and accessible by any party), semi-public (unencrypted, but stored at a secure location only accessible by a select group of parties), or secure (encrypted, where only a select group of parties obtain the associated keys to decrypt the data). Having the variant database public may provide benefits for ease of use and may help, for example, in research use cases.

### How to Encode Phenotypic Data

In many cases, phenotypic data may be stored as a time series. For example, in the case of blood test result, an entry may look something like: “At <date and time>, the LDL value was 137 mg/dL”. A phenotypic value can be either numerical (e.g. height=177 cm) or categorical (e.g. type 2 diabetes). Like genomic data, phenotypic data can be encoded as numeric/Boolean vectors. This can be achieved by using some encoding of categorical data (either One-Hot Encoding or 1 to k values).

How to Encode Expression Data

Unlike genomic data, which is identical in all the cells of the body (unless somatic mutation are involved), expression levels can vary dramatically between different cells of an organism (especially between different tissues) and between different measures. Moreover, results can be affected by the exact method and platform used for measurement, so the processing of the results is platform-dependent. Therefore, when storing expression results of a patient, some embodiments of the invention may also store meta-data associated with the expression results (e.g. sampled tissue, sampling method, used platform, etc.). Each platform usually looks at a different subset of transcripts, so this meta-data should be confidential (e.g. encrypted) as well.

Expression results of a single sample may be a mapping between transcripts (e.g. which usually correspond to genes) to their expression values, which can be measured by exact read numbers, or normalized values. Like genomic data, expression results can be represented as a numerical vector. The length of this vector may remain concealed (e.g. by padding the vector with zeros to make the vector's length equal to a maximum possible length or predefined default length), as the vector length may reveal the platform used.

### Ciphertexts

After discussing how genomic, biological and medical data can be encoded as plaintexts, a description of generating the corresponding ciphertexts follows (e.g., as performed in operation 107 of FIG. 1).

This document has described how sensitive types of data can be encoded as vectors of Boolean or numerical values. Boolean values are a special case of integer values, and non-integer numbers can also be converted to integers by limiting their precision (e.g. only up to five digits after the decimal point). Accordingly, in some embodiments, the plaintexts that have to be encrypted may be encoded as integer vectors.

Encryption algorithms (e.g. BGV, BFV and LTV) used according to embodiments of the invention may work on fixed-length data blocks. Thus, prior to encryption, plaintexts may first be broken down into chunks, blocks or segments (e.g., as performed in operation 105 of FIG. 1), where the last one or more chunks or blocks may potentially be padded with zeros. Each chunk or block may then be encrypted independently, obtaining a series of independent ciphertexts (e.g., as performed in operation 107 of FIG. 1).

Whenever a piece of data is to be retrieved or used in a homomorphic calculation (e.g. to determine the value of some allele), the computation host may first resolve the index of the relevant value in the plaintext vector into the index of the relevant chunk or data block and the index of the relevant value within this chunk or data block. Since every chunk or block of data is encrypted together as an entire piece of ciphertext, the relevant value may be manipulated together with all the other values stored in this ciphertext, whether these values are relevant to the calculation or not (e.g. irrelevant values may be wiped out along the process to avoid the disclosure of unnecessary information).

If the values in the plaintext vector are ordered such that related pieces of data are in proximity to each other (e.g. sorting variants and expression values according to their genomic location), such related values will often end up in the same ciphertext, allowing embodiments of the invention to improve performance using SIMD operations. Genetic tests, for example, often involve variants from the same genes, which are likely to inhabit the same ciphertexts according to representations described herein.

When new variants are discovered, existing genome representations may be appended with placeholder entries or zeros to unify vector lengths. If zeros are added to the last plaintext block, there may be no need to update the ciphertext, as it is already padded with zeros. If a new block is required, the computation host will have to create an all-zero ciphertext, which is trivial to do in the BGV, BFV and LTV scheme using the public key of the relevant party.

Algorithms and methods described herein are applicable, not only to the ciphertexts as described above, but can also be applied to any ciphertexts of an FHE and FE scheme.

### Incorporating AES Ciphertexts

For various reasons (e.g. compactness), it may be preferable to transmit and store data encrypted by AES rather than BGV, BFV and LTV (or any other FHE scheme). Frameworks according to embodiments of the invention can support AES schemes and allow the computation host to convert AES-encrypted ciphertexts into FHE-encrypted ones.

Converting AES-encrypted ciphertexts to FHE-encrypted ciphertexts may involve evaluating the AES decryption circuit homomorphically, given a FHE-encryption of a symmetric AES key used to encrypt the data. This process can be safely executed (e.g. even on an untrusted server), by FHE encrypting the involved AES keys, giving the server the power to evaluate FHE circuits on the data, but not to decrypt the ciphertexts. The conversion from AES to FHE can be executed on the fly, for example, involving only the ciphertexts required for that specific use-case. Furthermore, the exact details of the FHE cipher can be chosen in real-time as well, for example, in order to optimize the calculation being made. For example, circuits with low depth typically do not require high ciphertext modulus in the LTV scheme, and using the lowest sufficient modulus can spare precious computation resources. To improve performance and real-time latency, the server may use a cache of already-converted FHE ciphertexts.

In one example, if a data provider merely wants to look up some pieces of data stored in the computation host, there may be no need to use FHE, and the data provider may have returned his own relevant AES blocks to decrypt by himself. If, on the other hand, the data has to be delivered to another party, then transferring the AES encrypted data may expose the entire data encrypted in these blocks, even if only one bit was meant to be shared. In order to expose only the relevant portion of each data block (or only a calculation result) instead of the entire chunks or blocks of raw data, the computation host may convert the data from AES to FHE ciphertexts.

In order to allow flexible management and manipulation of ciphertexts, embodiments of the invention may encrypt each block of data independently. When AES (or any other block cipher) encryption is used, embodiments of the invention may not use most block cipher modes, which create dependency between the encryption of different blocks (e.g. as in ciphertext block chaining (CBC) mode). To ensure that different blocks are always encrypted differently, whether they have the same value or not (e.g. all zeros), embodiments of the invention may use a CTR (counter for block ciphers) mode, or another mode that uses the same initial value (IV) or the same nonce across all blocks together with some changing counter. Some embodiments may not use a different IV for each block as it may inflate the data by a factor of 2, wasting storage without adding significant benefit.

If data is stored on a server encrypted by AES rather than BGV, BFV and LTV, then adding all-zero blocks (e.g. when new variants are added to the public database) becomes more challenging, as AES is a symmetric encryption protocol, meaning that new blocks of data cannot be encrypted by another party using its public key. There are two possible solutions to handle this challenge. First, the computation host may simply not encrypt new blocks, whose value is already known to it anyway. Another solution may involve deriving new AES keys in a deterministic way that is known to both the data provider and computation host, and afterwards erasing traces such that the computation host would not be able to recover the keys. For example, the AES key of each new block may be a hash or other derivation of the key used for the previous block. The data provider, in this case, will have the AES key of the first block (allowing him, with some work, to derive all other AES keys), but the computation host will only keep the AES key of the next future block, from which no former keys can be recovered.

Although the special case of AES is described herein, any other type of encryption algorithm, and/or block encryptions in particular, could be used according to embodiments of the invention.

### Elementary Operations

FHE, by definition, allows a processor to evaluate any computation on encrypted data. However these computations are not always efficient. In this section, embodiments of the invention implement the most prevalent computations that one may want to evaluate on encrypted data. Examples described herein primarily focus on genomic use cases, though most of these operations are useful also for other types of secret data (e.g. phenotypic or expression data). Indeed many of the use-case examples described herein can be trivially reduced to the set of elementary operations executed according to embodiments of the invention. Efficient implementations may dependent of the data representation described herein.

Each operation described herein may be properly formulated (e.g. in terms of inputs and outputs), and embodiments of the invention may include implementation that rely e.g. on FHE primitives (and BGV, BFV and LTV in particular). Some implementations may take into account SIMD optimizations and parallelization, as well as circuit depth and performance issues. Most implementations will assume that the relevant pieces of data are already FHE-encrypted (e.g. converted from AES if needed).

Some embodiments of the invention may use a relaxed security model by which only the data has to be protected, but not the calculations performed on the data. Other embodiments of the invention may use a stricter model, which also protects the calculations, causing some of the details or calculations to be revised accordingly.

### Update Data

One of the simplest operations a data provider may want to perform with data is to update the data. An update operation can either add whole new data points and vectors, or override existing ones. When new data is uploaded, relevant bits in the certainty mask (e.g. marking whether the data is known) may be updated accordingly e.g. from 0 to 1, indicating that these values are now known. A data provider can also choose to delete some (or all) of the data, updating the relevant bits e.g. back to 0.

### Lookup Values

Another operation a data provider may want to perform with his stored data is to look up or retrieve certain pieces (or all) of the data. Since all the secret data is stored in the computation host as a vector of integers, the data provider only needs to indicate to the computation host the indices in which he is interested. The computation host server may then retrieve the relevant ciphertexts, and extract the relevant values from them, sending the result to the transaction's recipient (e.g. the data provider).

If the recipient of the operation is the data provider himself, the computation host may send the relevant complete ciphertexts to the data provider, who may execute a processor to decrypt and extract the relevant information at the client-side. If the data is AES-encrypted, then there may be no need to convert the data to FHE, and the data can remain AES-encrypted when sent back to the data provider. However, when the recipient of the operation is a party other than the data provider, the computation host may extract only the relevant values from each ciphertext (e.g. wiping out or deleting the rest). Such embodiments may convert the ciphertexts to FHE using the associated keys.

The relevant values may be homomorphically extracted from a ciphertext in at least the following way. First, embodiments of the invention may extract each of the values one by one, obtaining a separate ciphertext for each value. Another embodiment, which in some cases will be more efficient, is for a processor to AND (i.e. multiply) the ciphertext with a relevant mask, erasing all the irrelevant values. The latter approach may benefit from the SIMD optimization, and both methods may use parallel execution.

### Linear Weighted Sum

Many use-cases can be reduced to the operation of a linear weighted sum. In its most general form, a processor computes the sum Σᵢwᵢ·fᵢ(ν) where νᵢ are some data values (e.g. allele values) and wᵢ are the summation weights. fᵢ are conversion functions for interpreting the relevant data values. When dealing with numeric values (in particular Boolean), they will usually be the identity functions, obtaining the simple form Σᵢwᵢ·νᵢ. When dealing with categorical data (other than binary) encoded as integers, the calculation may become ΣᵢΣⱼwᵢⱼ·comp(νᵢ, j). Here wᵢⱼ may be the weight for value i being the j category. Since this computation involves a comparison operation (cmp), evaluating this homomorphically may or may not be efficient depending on the underlying FHE. Embodiments of the invention may use One-Hot Encoding (OHE) to achieve a possible more efficient for categorical data, for example, by leaving the data in binary form and reducing calculations to the simple form e.g. Σᵢwᵢ·νᵢ. Usually only a small portion of the data is of interest to any single test, meaning that most of the weights will be zeros, allowing embodiments of the invention to exclude the irrelevant data from the operation. Since in some embodiments of the invention the weighted sum is evaluated homomorphically, it may be convenient to view the weights as integer valued, which can be achieved by representing the weights as fixed precision floating points.

Homomorphically evaluating a weighted sum in its simplified form may be computationally efficient, as it involves evaluating scalar multiplications and additions, both of which are efficient linear FHE primitives. SIMD optimization can be used in the multiplication step, where all the values on the same ciphertext can be multiplied together with their respective weight. This calculation may also be executed in parallel, thereby increasing computational speed, as each set of the ciphertexts can be evaluated independently, e.g. summing everything up only at the end of the independent ciphertext calculations.

In some embodiments, tests may apply a non-linear transformation on the data as a pre-processing step prior to the evaluation of the linear weighted sum. For example, a genetic test may give different scores to heterozygous or homozygous genotypes. Let νᵢ and νᵢ₊₁ be the maternal and paternal allele values with respect to a variant for which zygosity affects the score given for the presence of the variant. If the score for a variant present in only one of the two alleles is w and the score for a variant simultaneously present in both alleles is W, then the relevant part of the weighted sum would be w·νᵢ+w·νᵢ₊₁+(W−2w)·νᵢν₊₁. More generally, when a genetic test models zygosity in any way that is not additive (e.g. W≠2w), then evaluating it may involve a pre-processing step of calculating the multiplications νᵢνᵢ₊₁ for all the non-additive variants.

### Test for Specific Value Matches

This operation checks whether or not there are any “suspicious” values in one's data. This check may be generalized as computing the function ∨ᵢ(σᵢ ∈ Sᵢ), where ∨ denotes the logical OR operation, and Sᵢ denotes the suspicious values in each location (most tests do not consider many values, and Sᵢ=∅ in nearly all locations). By encoding the data as Boolean data, the check can be simplified to ∨ᵢ(wᵢ₁·νᵢ∨wᵢ₂·̂νᵢ), where ̂ is the NOT operator, and wᵢ₁, wᵢ₂ are binary weights that determine whether the test checks whether νᵢ is positive or negative (or indifferent to this value when both are 0).

After a pre-processing step that evaluates the NOT operator for the relevant variants, this entire calculation can be reduced to an OR operator, which may be evaluated as disclosed herein. Here as well, the test may begin with a non-linear transformation (e.g. if testing for a homozygous genotype).

### Aggregation

Operations can also be built using a hierarchical structure, where the outputs of a first operation can be used as the input of another second operation one level higher, which can then be fed to another third operation, and so on. The following aggregation functions may be supported: MIN, MAX, SUM, MUL, AND, OR, and/or BOOL.

A genetic test, for example, can be modeled as MAX(1·E₁, 2·E₂, . . . , r·Eᵣ) where Eᵣ is an indicator function e.g. stating whether or not a patient has any deleterious variants of level r. The test result in this case may be the pathogenicity level of the most deleterious variant found in a genome (or 0 if the genome has no variants). The greater the pathogenicity level of a variant, the graver the patient's condition may be, so the test may determine only the level of the most deleterious variant found in the genome (when there is no need to disclose information about less severe variants). In other embodiments, all, a predetermined number N, or a subset of sufficiently harmful, variants may be reported by the test. Embodiments of the invention may evaluate this test homomorphically, which may cause the computation host to evaluate r independent tests (e.g. “test for specific value matches”), multiplying the result of each test by a scalar, and then aggregate all the results using a MAX function (homomorphically).

There is typically a tradeoff between confidentiality and performance when aggregators are involved. Instead of evaluating the whole computation hierarchy homomorphically, the host may evaluate only the underlying bottom-level computations (e.g. “leaves” in the computation tree), and send all the intermediate results to the recipient to do the aggregation on its own. This would allow embodiments of the invention to perform the aggregation in cleartext rather than homomorphically, which typically improves performance. However, such embodiments may also expose the underlying intermediate results, rather than just the final result, thus disclosing more information than may be necessary. If the recipient is the same party who owns or generated the data (and is also aware of the exact computation being performed), then there may be no reason to perform aggregation homomorphically, and the aggregation may occur without encryption at client-side. Homomorphic aggregation is typically only useful when more than one party is involved.

### Create Contingency Table

Research use-cases, and association studies in particular, often begin with a contingency table showing the relation between two categorical variables. In order to create the table, the computation host may receive a fixed set of rules for classifying each record (e.g. associated with an individual) to one of a fixed set of categories for each of two or more variables. The computation host may then generate a table whose dimensions correspond to the number of categories of each of the two or more variables, and whose (i,j) entry will count the number of records matching category i for the first variable and category j for the second, and so on for additional variables.

For example, assume that an association study tries to learn the connection between an individual's genotype (with respect to some variant) and the individual's susceptibility to a certain disease. Assuming a binary variant with alleles A and a, the possible genotypes would then be AA, aa or Aa (which may be equivalent to aA). Let's further assume that a person can either have or not have the disease, so the disease can be modeled as a binary trait (0 or 1). In order to learn whether or not there exists a connection between the individual's genotype and phenotype in this study, a researcher may create e.g., a relevant 2×3 contingency table, counting the number of individuals in the relevant dataset (e.g. who agree to participate in this study) having each of the exact genotype-phenotype combinations.

If all of the relevant values are Boolean (which can be achieved given the right encoding), then the rules to define the categories of each variable can be encoded using masks. Each mask defines what indices of the data are being analyzed, and the values expected at those indices (e.g. 0 or 1). Each category will then be encoded as the set of all the masks satisfying this category. In the case of a ternary genotype, as described above, assuming that the allele values A and a are encoded as 0 and 1 respectively, the masks for the AA genotype will be {00}, for the aa genotype will be {11}, and for the Aa genotype will be {01, 10}. Each mask may also include the indices of the two alleles being analyzed in the data (for convenience of notation, this may be modeled implicitly).

By using masks of any size looking at any number of values, data representation according to embodiments of the invention can in fact encode any genotype (even genotypes comprised of an arbitrary number of variants in an arbitrary number of genes), any phenotype, or even variables that are a combination of phenotypes and genotypes, or any other data.

In order to evaluate a contingency table homomorphically, the computation host may evaluate each of the masks on each of the records separately, by determining whether that record satisfies the mask. The value of the (i,j) entry in the table may then be Σₘ_{₁}_{∈M}_{₁ᵢ}Σₘ_{₂}_{∈M}_{₂ⱼ}Σ_{r∈R}χ(r, m₁)·χ(r, m₂), where M₁ᵢ is the set of masks for category i in the first variable and M₂ⱼ is the set of masks for category j in the second variable. R is the set of records participating in the study, and χ is a Boolean function checking whether a given mask satisfies a given data record. In other words, χ is a string comparison (where the compared strings are the mask and the relevant part of the data record), which may be evaluated homomorphically as described herein. In order for this calculation to run correctly, all the masks defining a category should be mutually exclusive, to prevent double counting. After the Boolean function χ is applied to the data, the calculation may involve only one level of multiplication between χ(r, m₁) and χ(r, m₂), and then only summation. Both are trivial to evaluate homomorphically. This calculation may also be executed in parallel, as computations can evaluate every entry in the table independently, and even all the additive elements in the summation of an entry can be independently calculated.

Although, for the sake of simplicity, this section discussed two dimensional contingency tables (i.e. where two variables are compared against each other), embodiments of the invention may be generalized to any dimension (i.e. comparing any number of variables against each other, e.g. resulting a high-dimensional tensor with an entry for each combination of values).

### Merging Genomic Sequences

Embodiments of the invention include systems and methods for merging two genomic sequences. Namely, consider the scenario where two (not necessarily disjoint) sets of genetic segments or locations have been sequenced and encrypted with a sparse genomic representation defined according to embodiments of the invention. Embodiments of the invention aim to compute a function on the merged sequence of the two sets, either by explicitly merging the sets into a single sequence, or otherwise.

With a sparse data representation, the two partial sequences may be merged efficiently into a single merged sequence. Recall that in the sparse data representation described herein, the presence of a variant may be denoted e.g. by a ‘1’ and the absence of the variant may be denoted e.g. by a ‘0’. Assume for simplicity that the two partial sequences are consistent; that is, they do not have contradictory values in any location. Then, a processor may compute the merged sequence by computing a coordinate-wise “OR” (which in turn can be computed using multiplications mod 2, after applications of the de Morgan formula) of the partial sequences. p Alternatively, a memory may store an unencrypted indication of the loci or locations that have been sequenced. A processor may then compute the merged sequence by computing a coordinate-wise “XOR” (addition mod 2) of the partial sequences, which may be more efficient than the “OR” computation in the homomorphic encryption context because of slower noise growth and faster computation times.

### Key Management and Data Delegation

Embodiments of the invention may include systems and methods for coordinating permissions, key management, and flow of data between the different parties. Embodiments of the invention propose a host of solutions to create a framework that is practical in the real world. Embodiments of the invention may work according to systems and methods described for example in U.S. Patent Application Publication No. 2017/0155628, entitled “Device, System and Method for Fast And Secure Proxy Re-Encryption.”

### Foundations

In one embodiment, each party may use its own set of public and private keys, for encryption and decryption, respectively. Each party shares only public and special evaluation keys, which cannot be used for decryption. Secret keys (e.g. including AES keys), which can be used for decryption, are never shared in this embodiment.

Each party may use a different key to encrypt different ciphertexts, potentially encrypting each data block with a unique key to enhance security in various scenarios (example will be shown below).

Regardless of the number of different keys used by a party, each party may only need to keep one master key, which can be used to generate all other keys, including secret, public and evaluation keys. In some embodiments, the master key can be used as a random seed from which all other keys may be generated deterministically. Block indices can also be incorporated into the seed, in order to ensure different keys for different blocks.

Once the data is encrypted under certain keys (whether or not the keys are the same for different blocks), each transaction can potentially use a different one-time key randomly chosen on-the-fly in order to conform all relevant ciphertexts to the same key. If a party's data is AES-encrypted, the party may send the computation host the relevant AES keys FHE-encrypted under this one-time key. If the data is already encrypted with FHE, Proxy Re-Encryption (described below) may be used in order to conform all the relevant ciphertexts to the same one-time key.

### Proxy Re-Encryption

Suppose that two parties have two independent sets of public and secret keys (pk1, sk1) and (pk2, sk2). Proxy Re-Encryption (PRE) is a technology that allows party1 to take its secret key sk1 and the other party's public key pk2 and create a re-encryption key rk12 that allows one to turn ciphertexts encrypted with pk1 into ciphertexts encrypted with pk2 that decrypt to the same plaintext. Importantly, the PRE key does not allow one to decrypt pk1-encrypted messages. BGV, BFV and LTV supports PRE. PRE may be used as described in U.S. Patent Application Publication No. 2017/0155628, entitled “Device, System and Method for Fast And Secure Proxy Re-Encryption.”

PRE may be useful to address honest-but-curious adversaries, as PRE allows parties to provide a semi-trusted server with re-encryption keys, thus allowing them to distribute some of their data (or computation results over the data) to another party that has been pre-approved by the parties (when generating the re-encryption keys and sending them to this semi-trusted server).

### Data Delegation

PRE capability may be used to support delegation of data and delegation of the results of computation on data for genomic data. Suppose that a certain calculation is made on the data of one party A, but the result has to be sent to another party B. For example, A could be a patient and B the patient's care provider who needs to get A's test results. Generally, A and B might be any pair of parties described herein.

In such use-case, the computation host may change keys somewhere during the process, in order to have the result encrypted under B's key rather than A's key. This change of keys should be preferably done in a way that does not involve decryption of the data, or any other disclosure of secret keys, as otherwise the honest-but-curious security model of the computation host could be violated and party A's data could become insecure.

PRE may be used to change keys and convert data between parties. Party A providing a re-encryption key can be considered as party A providing consent to delegate the involved data to party B or only the results of computation on the data to party B. The PRE server can then use the re-encryption keys to re-encrypt all the relevant ciphertexts prior to the computation, or to re-encrypt only the result of the computation or tests on the data at the end of the computation.

In order to improve security, the PRE server may be independent of the computation host (e.g., a different physical device that may be located in a different network or physical location, or even belong to an entirely independent organization). This way a malicious attacker would have to breach the securities of both the computation host and the PRE server in order to obtain parties' data when the data is encrypted in a different key than their own.

If the relevant ciphertexts of party A are AES-encrypted, then, instead of using PRE, party A may send its AES keys encrypted with the FHE public key of party B, so FHE evaluation of AES decryption would result in FHE ciphertexts encrypted under party B's key rather than party A's. From hereon, computations on the ciphertexts, which were previously encrypted under A's AES key, can be performed using party B's FHE evaluation key. In this scenario as well as in other embodiments of the invention may, another independent server different from the computation host may manage the AES-to-FHE keys and data conversion. This would provide the benefit of isolating this sensitive task from the computation host, which has access to all the relevant ciphertexts. Alternatively, the computation host may manage the keys and data conversion.

Once a party sends a key (or an AES key encrypted under another party's FHE key), the party may no longer have full control over the data encrypted with this key. If all other parties are malicious and conspire against the party (or if the other parties are hacked by a malicious third party), they may be able to learn some of the party's information encrypted under that key. Accordingly, it may be important to isolate and disconnect the PRE server from the computation host (e.g. using different devices, separated by security layers). This security risk also provides motivation for encrypting each of the party's ciphertext with a different key (so a data provider will not have to give up more information than the minimum required).

Alternatively or additionally to the proxy re-encryption methods, embodiments of the invention may use two or more layers of encryption. In such embodiments, a processor makes all the calculations with party A's key, and only when a final result is obtained encrypt it yet again with party B's key, obtaining a result encrypted under both party A's and party B's keys (e.g. without carrying complicated multiparty computations along the entire process). This double encrypted result may then be sent to party A, which may remove its layer of encryption and send the result to party B (directly or via the computation host). Party B will then have the result encrypted only with its key. In some embodiments, the cryptosystem may be insensitive to the order of encryptions/decryptions (which is the case for BGV, BFV and LTV). This protocol may be slightly more complicated, but typically provides greater security for the data provider, who never has to give up on sole possession of its keys. The use of double layer of encryption may ensure that party A will not be able to read the result intended for party B, which might be important in some use-cases (e.g. a care provider may not want her patient to get the test result without her consent).

Some use cases involve more than two parties. For example, the “crate contingency table” operation, described herein, could potentially involve a very high number of different data providers (e.g. when every individual is the data provider of his own genome, which is used in a research study). This complication can be solved by re-encrypting the relevant parties' data to the same key prior to the evaluation (usually the key of the researcher, who is the recipient of the transaction). Once consent has been given by the various data providers to participate in this study, the PRE server may then generate suitable re-encryption keys to re-encrypt the data from the individual participant's key to the researcher's key. Alternatively or additionally, re-encryption of the data may be solved by multiparty calculation, e.g. with only addition operations performed over intermediate results of different parties in this case (without any multiparty multiplications, which dramatically enhances performance). This approach may involve all the parties who have participated in the study to be available during the mutual decryption process.

Embodiments of the invention include a system and method to provide:

Application of PRE to a genomic data context.

Double-encryption approach e.g. to ensure data is accessed only if all (two or more) parties agree.

Encryption of AES keys with PRE to enable conversion of AES encrypted data to data encrypted under other keys.

Encryption of AES keys with PRE to enable conversion of AES encrypted data to data encrypted under FHE keys.

Separation of the PRE server and all other servers

Multi-party calculations of re-encryption using a PRE approach. Re-encryption using multi-party computation protocols.

### Obfuscation of Tests and Research Computations

Different use-cases may be used when only the data has to be protected, only the test, or both. Embodiments of the invention may include systems and methods for protecting not only the data, but additionally or alternatively, protecting computations (calculations) performed by a processor on the data.

Embodiments of the invention protect general computations (calculations) on data, and include preferred solutions for special computations (calculations) to be carried out on the data. Preferred solutions may, in some examples, include modifications of data representation described herein.

### Encrypting Key-Value Pairs

Embodiments of the invention may choose various data encoding methods so as to enhance the secrecy of the calculations that are being performed (or which tests are being run) on the data, from the computation host.

For example, in one embodiment of the invention, in the case of genomic data, the mapping between key (e.g. representing an allele) to value, may be encoded as a vector of encrypted values, leaving the corresponding keys (e.g. representing alleles) in plaintext for quick lookup.

Instead other embodiments use a different approach and encrypt the key-value pairs together (e.g. by giving each key a unique identifier).

Once the keys and values are both encrypted, any computation that involves looking at a subset of the data may be compiled into a circuit looking at all key-value pairs homomorphically.

For example, a homomorphic evaluation of a computation testing for a specific allele in an individual's genome may be represented as: Σ_{key,value}cmp(key, specific—allele—key)·value, where the sum is iterated over the key-value pairs in the individual's genome and specific—allele—key is the key of the specific allele for which this calculation is testing.

Since the keys are now encrypted too, this encoding can become even more compact by storing only keys for which the values are not trivial (e.g. storing only the variants that are actually present in an individual's genome, not all variants, e.g. where the value is 1 in the binary representation and not 0). This results in a much more compact representation without compromising security. If we assume that the data values are binary, the same computation may be calculated e.g. as: Σ_{key}cmp(key, specific—allele—key)

Since every such computation may be iterated over the entire data set of the data provider, the computation host remains clueless as to which computations are being run.

### Data Permutation

In one embodiment, the efficient vector representation disclosed herein may be used, but may be permuted in a pseudo-random manner, for example, determined by a secret nonce (e.g. an arbitrary number or code that may only be used once) that may serve as a seed for generating pseudo-random numbers defining the permutation. This nonce will typically not be known to the computation host.

In one embodiment, the vector representation of key-to-value, in which values are encrypted but keys are kept in plaintext, may be used, but the keys may be permuted in a pseudo-random manner, for example, determined by a secret nonce. This nonce will typically not be known to the computation host.

In such embodiments the data provider may share the nonce with a test provider (the nonce may still be considered secret since the test provider already knows what test is being computed) in a side channel unknown to the computation host, to allow the test provider to compile its test in accordance with the data provider's data permutation (e.g. looking at the correct indices or keys of the data of interest). Alternatively the test provider may give the test to the data provider, who may compile the test at the data provider-end. Once the test is ready to run on the data provider's unique data, the test may be executed by the computation host device without providing the computation host with the nonce. Although the computation host can execute the test, it may not be able to understand the results of its own computations. In contrast, the results of executing the test can be understood by the data provider and in addition (or alternatively) the test provider, who know the nonce.

In some embodiments, data permutations may cause a performance penalty by interfering with the SIMD optimization, as shuffled indices may result in related data values that were on the same ciphertext prior to the permutation, now being sent to completely different ciphertexts. A way to overcome this would be to only shuffle the blocks of data and the data within each block, leaving the chunking or ordering of the data blocks unaffected.

### Test Encryption

A secure approach may be to encrypt the details of the computation while leaving the data representation as is. This can be done in addition to an encryption of the data or without encrypting the data, by using same or different keys for encrypting the data and encrypting the test.

If different keys are used, the results of executing the test may ultimately be encrypted by two layers of encryption (with the data provider's and test provider's keys), and in order to decrypt the test results, each of the two parties involved may have to remove its layer of encryption. Decryption may be order independent (e.g. the two keys can be applied to decrypt the data in either order).

For example, the data provider could first remove his layer, and then the test provider would remove its layer. In order to hide the test result from the test provider, the data may be homomorphically masked by the computation host, using a nonce shared by the data provider and the host.

Alternatively, if we want to avoid the complications of multi-party calculations, the data provider and the test provider would have to bring their data and test to be encrypted under the same key using a re-encryption technique (potentially utilizing the PRE server described herein). This key could be the data provider's key, test provider's key, a trusted third-party's key, or a one-time key agreed to by both parties. The key choice may depend on efficiency desired and the particular trust model.

By remaining with a vector representation of the data, embodiments of the invention avoid the potentially more inefficient string/integer comparisons (as in 0 the “encrypting key-value pairs” option). When the evaluated test looks only at a subset of the data, embodiments of the invention may use an encrypted binary mask defined by ones only at the indices that the test is actually looking at and zeroes elsewhere.

If, for example, the evaluated calculation is a test checking whether or not an individual has any of a given set of variants (the “test for specific value matches” operation), the test may be compiled to a binary mask of the same size as the genome vector. The value of the mask at each location will be whether or not the test is analyzing the allele at that index. When evaluating the test, the computation host may homomorphically check whether or not there exists an index where both the bit of the mask and the bit of the genomic data are turned on.

Such mask-based computations may, like the approach of encrypted key-value pairs, iterate over the entire data set of the relevant data provider. If the computation host is to know absolutely nothing about the test, the complexity incurred by operating over the entire data is inherent, as avoiding operating over certain indices may indicate to the computation host that these values aren't relevant to the test, thus disclosing some information about the test.

There is a delicate tradeoff between the extent of security guaranteed to the involved parties and the efficiency of the calculation. A middle ground option may be to encrypt only parts of the test mask, allowing the host to learn some information about the portion of the genome the test is operating over, but not the exact variants being analyzed.

For example, encrypting only exome locations in the mask may reveal little about the performed test, while sparing a lot of unnecessary computations involving intronic and intergenic regions.

### Implementing Obfuscation for Elementary Operations

Embodiments of the invention may include systems and methods for obfuscating the details of elementary operations by relying on the encrypted masks method. Note that for each of the described operations, the mask may be encrypted using the same or different key as the data. When the keys are different, multi-key decryption methods and multi-party computations to decrypt may be utilized.

Lookup values

When the details of the lookup need to be obfuscated, encrypted masks may be used, for example, using an AND operation between the ciphertexts and the masks.

### Linear Weighted Sum

Obfuscating the test in this operation may involve encrypting weights of the test computations (with some or all of the zero weights optionally encrypted too, in order to hide which data points are being operated over).

### Test for Specific Value Matches

The test operation may calculate ∨ᵢ(wᵢ₁·∨σᵢ159 wᵢ₂·̂νᵢ) where wᵢ₁w₁₂ may be binary weights and \hat{ν}ᵢ indicates the negation of νᵢ. By encrypting these weights (including when weights are zero (0) as well as non-zero), the details of the test can be obfuscated.

### Aggregation

Although all circuits or portions of the computational test may be obfuscated, doing so for some of the computational aggregators may not be efficient. Some embodiments of the invention may obfuscate only the details of the lower levels of the computation tree (the leaves), which are where the sensitive information often lies (namely, which values are actually looked at; e.g. defining which variants are part of the genetic test). In the case of multiplication (MUL) and summation (SUM), embodiments of the invention may hide constants that are being used in the computation (e.g. hiding the scalars multiplying each indicator function of the variants, in the example of the aggregation operation).

### Create Contingency Table

When the researcher wants to keep the details of her study a secret, she can obfuscate the identity of the exact values that she is actually looking at. This may be achieved by using, again, encrypted masks.

These encrypted masks that determine which indices of the data are actually being looked at should not be confused with the masks described earlier in this operation, which only determine the expected values in those indices. According to embodiments of the invention, M₁ᵢ and M₂ⱼ (in the formula below) may be not just a set of masks (and implicit indices), but rather a set of mask pairs (one of each type), determining both the indices being operated over and their expected values. Accordingly, the computation for the set of masks is:

$${Σ}_{{m}_{1} , {\hat{m}}_{1} ∈ {M}_{1 i}} {Σ}_{{m}_{2} , {\hat{m}}_{2} ∈ {M}_{2 j}} {\sum }_{r ∈ R} χ ( {\hat{m}}_{1} ⋀ r , {m}_{1} ) \cdot χ ( {\hat{m}}_{2} ⋀ r , {m}_{2} )$$

where ∧ is the point-wise AND operator (i.e. point-wise multiplication). Assuming that all the data points have already been converted using the recipient's key (or a common one-time key), the data points and the masks will be given in the same key, so the only performance hit will come from the additional ∧ operators (one more multiplication), and the fact that more ciphertexts may be evaluated (e.g. in order to obfuscate the ciphertexts that truly matter). As mentioned, there's a tradeoff between security (e.g. evaluating more dummy ciphertexts) and performance (e.g. skipping masking regions of the genome that are irrelevant to the test).

### Efficient String Comparison in the SIMD Representation

Embodiments of the invention provide a method and system for computing “implicit AND” of n bits. That is, imagine that you have n bits encrypted in a single ciphertext in a SIMD fashion. The goal is to compute a homomorphic AND of these n bits, for example, better than the trivial method where the SIMD “extraction” procedure is used to extract each of the n bits into its own ciphertext and compute the homomorphic AND.

The method described here for computing an “implicit AND” will in turn improve the string comparison operation described herein.

The main observation is that in one shot or computation, embodiments of the invention may construct two ciphertexts, the first of which may encode the first half of the bits and the second of which may encode the second half of the bits. Such encoding may be executed using the SIMD extract operation described herein. After encoding the two ciphertexts, embodiments of the invention may execute a homomorphic AND of these two ciphertexts. This operation may result in a single ciphertext encoding n/2 bits whose AND is the same as the AND of the original n bits. Embodiments of the invention may proceed iteratively for log n levels until the final AND is computed.

The total cost of the operations is log n extract operations plus log n homomorphic ANDs, as compared to n extract operations and n homomorphic ANDs when done in the trivial way.

### Token Based Obfuscation Model

Embodiments of the invention provide another model for enabling a computation host to perform secret computations on biological, medical and genomic data without learning the details of the underlying data or the computations. In fact, the computation host may learn nothing about the data or about the computations, except the results of running the computations on the data.

The secret computation may be any computation for commercial, research or any other purpose. For convenience, embodiments of the invention may refer to the computations as a “test” and to the test owner as the “test provider”, although any other computation and party may be used.

Embodiments of the invention provide a system and method for the test provider to transform an original (e.g. unprotected) test T into a so called obfuscated (e.g. garbled or encrypted) test T′. Because test T′ is obfuscated, it can be stored in the computation host or another location (which may be potentially insecure), and may be available for anyone to see or duplicate. The obfuscated test T′ does not reveal anything (or reveals minimal information) about the test T, although the result of running the original test Ton data D is the same as the running the obfuscated test T′ on an appropriate encoding of data D provided in the form of a digital token (as described below).

Obfuscated test T′ typically cannot be used to compute original test Ton data D, unless the test provider provides a digital token referred to as Token(D) which constitutes an encoding of data D which enables performing the obfuscated test T′ and also provides an authorization for performing the obfuscated test T′ on data D

Given the obfuscated test T′ and Token(D), the test result T(D) can be computed. Access to many tokens Token(D₁), . . . , Token(Dₖ) each for different data items D₁, . . . , Dₖ, may enable the test results T(D₁), . . . , T(Dₖ) to be computed. However, it may not be possible to compute the original test T on any other data item D′ different from D₁, . . . , Dₖ.

A token-based method may be implemented in some embodiments of this invention by the following operations:

Tk.Setup: outputs a set of keys SK

Tk.obfuscate: inputs a set of keys SK and a description of an original test T and outputs an obfuscated version of the test, T′.

Tk.Token: inputs a set of keys SK and data D and outputs token Token(D).

Tk.Evaluate: inputs an obfuscated test T′ and token Token(D) and outputs the result of the test Ton the data D, namely T(D).

Other or different operations may be used to achieve the same or similar functionality.

In some embodiments, the results T(D) of Tk.Evaluate may be returned in an encrypted form that may be further decrypted.

Implementation Based on Secret-Key FE

Embodiments of the invention provide a system and method for implementing the token-based method using the following two cryptographic primitives.
1. A secret-key functional-encryption scheme for a class of functions F. A secret-key functional encryption SFE may be defined by a tuple of algorithms SFE=(SFE.Setup, SFE.KeyGen, SFE.Enc, SFE.Dec). SFE.Setup inputs the security parameter and outputs a master secret key msk. SFE.KeyGen inputs the master secret key msk and a description of a function f in F and outputs a key skf. SFE.Enc inputs the master secret key msk and an input D and outputs a ciphertext “c”. SFE.Dec inputs a key sk and a ciphertext c and outputs a value “y” such that: y=D when both c=SFE.Enc(msk,D) and sk=msk; and y=f(D) when both c=SFE.Enc(msk,D) and sk=SFE.KeyGen(msk,f).
2. A secret-key encryption scheme E=(Gen, Enc, Dec) (such as the AES scheme). Gen inputs a security parameter and outputs a key sk; Enc inputs the key sk and a message m and outputs a ciphertext c; Dec inputs the key sk and a ciphertext c and outputs the message m.

In one embodiment, an implementation for the token-based scheme may proceed as follows using SFE=(SFE.Setup, SFE.KeyGen, SFE.Enc, SFE.Dec) and E=(Gen, Enc, Dec):

Tk.SetUp (security parameter k):
Run SFE.Setup (security parameter k) to compute msk.
Run Gen (security parameter k) to compute the key sk.
Output SK=(msk, sk).

Tk.Obfuscate (SK, T) where test T is a description of a function in F and SK=(msk, sk):
Let C=Enc(sk, T).
Define a function G (sk, D) that gets two parameters sk and D, decrypts T=Dec (sk, C), and outputs T(D).
Output T′=SFE.KeyGen(msk, G).

Tk.Token (SK, D) where SK=(msk, sk):

Set x=(sk, D).

Output Token(D)=SFE.Enc(msk,x).

Tk.Evaluate(T′, Token(D)):
Output SFE.Dec(T′, Token(D)).
   Other or different operations or orders of operations may be used to achieve the same or similar functionality.

Note that, in some embodiments, a party may encrypt multiple tests T and multiple pieces of data D with the same set of keys SK. The result of Tk.Evaluate(T′,Token(D)) will equal T(D) whenever the same set of keys SK is used in the computation of test T′ and the computation of Token(D), for example, when T′=Tk.Obfuscate(SK, T) and Token(D)=Tk.Token(SK, D).

In some embodiment the secret key SFE can be replaced by a public-key functional encryption (FE) comprising a tuple of algorithms FE.Setup, FE.KeyGen, FE.Enc, FE.Dec (e.g. replacing SFE.Setup, SFE.KeyGen, SFE.Enc, SFE.Dec respectively, in the above description).

In some embodiments the secret key SFE can be replaced by a bounded-key secret-key functional encryption (BK-SFE) comprising a tuple of algorithms BK-SFE.Setup, BK-SFE.KeyGen, BK-SFE.Enc, BK-SFE.Dec (e.g. replacing SFE.Setup, SFE.KeyGen, SFE.Enc, SFE.Dec, respectively, in the above description). In case BK-SFE is used, the number of keys generated by BK-SFE.KeyGen may be bounded by a predetermined number assigned as an additional input to the BK-SFE.Setup algorithm.

In some embodiments the secret key SFE can be replaced by a bounded-key public-key functional encryption (BK-FE) comprising a tuple of algorithms BK-FE.Setup, BK-FE.KeyGen, BK-FE.Enc, BK-FE.Dec (e.g. replacing SFE.Setup, SFE.KeyGen, SFE.Enc, SFE.Dec, respectively, in the above description). In case BK-FE is used, the number of keys generated by BK-FE.KeyGen may be bounded by a predetermined number assigned as an additional input to the BK-FE.Setup algorithm.

### Setting Example

A setting example for using the token-based model involves a test provider TP, data providers DP and a computation host CH:
1. Test provider TP may provide computations (e.g. genetic tests), compute SK=Tk.SetUp(1^{k}), and/or store the computations in a secure location.
2. For a particular test T owned or provided by test provider TP, the test provider TP may compute obfuscated test T′=Tk.Obfuscate(SK, T) and sends the test T′ to computation host CH to store.
3. Whenever a data provider DP wants to run the test T on its data D:
   a. DP sends a request with the data D to TP.
   b. TP computes Token(D)=Tk.Token(SK, D) and returns the result to DP.
   c. DP sends Token(D) to CH (or, alternatively, TP directly sends the token to CH).
4. CH computes Tk.Evaluate(T′, Token(D)) and returns the result to DP.
   Other or different operations or orders of operations may be used.
   Switching between the Data and the Test

In some embodiments, programs, computations or functions may be equivalent to data, and data may be defined as a function of functions. In one embodiment, given a test T and a data D, operating a test on the data resulting in an output T(D) may be equivalent to operating the data on the test resulting in the same output D(T). Since both data and computations are eventually encoded (e.g. as bits), they could both be encrypted, and the token-based model would work the same when switching the roles of the data and the test.

A dual token-based model would look, for example, as follow:

DTk.Setup inputs a security parameter and outputs a set of keys SK.

DTk.obfuscate inputs a set of keys SK and data D and outputs an encryption of the data D′.

DTk.Token inputs a set of keys SK and a test T and outputs a token Token(T).

DTk.Evaluate inputs encrypted data D′ and a token Token(T) and outputs the value of the test T on the data D, namely T (D).

In such embodiments, the data provider may be the party interested in keeping its data a secret, and may want to control computations on its data by allowing only approved parties tokens to run specific tests on its data.

### Efficient Token Based Model for Linear Weighted Sum

Embodiments of the invention provide a system and method for efficient token-based calculation of linear weighted sums on encrypted data.

First, the following public parameters of the system may be selected:

A number N which is a product of two large prime numbers p and q.

A generator g of the group G:= [symbol] *_{N}².

h:=N+1∈G

A party's secret key can be any secret allowing the party to generate secret numbers yᵢ∈G for every index i (or a subset of indices i). For example, a party can use a nonce K and define yᵢ to be a hash of K concatenated to the index i. Given this secret key, a vector of integers (x₁, . . . , xₙ) in G may be encrypted, for example, as follows. A random number r∈0,2N is chosen. Using r, compute c₀:=g^{r}∈G and for every i∈n compute cᵢ:=g^{r y}ᵢ∈G. The encryption of the data may be the vector c:=(c₀, c₁, . . . , cₙ).

Given the secret key, a token t for the weights (w₁, . . . , wₙ) ∈Gⁿ where t:=Σᵢ₌₁ⁿwᵢyᵢ∈G may be calculated. The knowledge of t allows the linear weighted sum Σᵢ₌₁ⁿwᵢxᵢ for encrypted data (x₁, . . . , xₙ)) to be calculated. Any party having an encryption c and a token t encrypted under the same key can calculate Σᵢ₋₁ⁿwᵢxᵢ, for example, as:

$${c}_{0}^{- t} {\prod }_{i = 1}^{n} {c}_{i}^{{w}_{i}} = {g}^{- rt} {\prod }_{i = 1}^{n} {g}^{{rw}_{i} {y}_{i}} {h}^{{w}_{i} {x}_{i}} = {g}^{- {rΣ}_{i = 1}^{n} {w}_{i} {y}_{i}} \cdot {g}^{{Σ}_{i = 1}^{n} {rw}_{i} {y}_{i}} {h}^{{Σ}_{i = 1}^{n} {w}_{i} {x}_{i}} = {h}^{{Σ}_{i = 1}^{n} {w}_{i} {x}_{i}} = {( N + 1 )}^{{Σ}_{i = 1}^{n} {w}_{i} {x}_{i}} = 1 + N \cdot {\sum }_{i = 1}^{n} {w}_{i} {x}_{i} ∈ G$$

(as N²=0 in G), from which Σᵢ₌₁ⁿwᵢxᵢ can be extracted.

Here as well, the data (x₁, . . . , xₙ) may be decrypted and tokens may be issued for weights (w₁, . . ., wₙ), or, equivalently, the weights (w₁, wₙ) may be encrypted and tokens may be issued for data (x₁, . . . , xₙ). For example, a data provider can encrypt his data and issue tokens for researchers, or a test provider can encrypt a test and issue tokens for using the test on specific data.

Learning with Errors (LWE)-Based Token Based Obfuscation for Linear Functions

Embodiments of the invention provide another system and method for efficient token-based calculation of linear weighted sums on encrypted data.

First, the following public parameters of the system may be selected:

A positive integer q, usually chosen to be a prime number.

A number n which is the security parameter of the system.

An error distribution χ which is a discrete Gaussian distribution with standard deviation σ.

In typical instantiations, σ may be chosen to be sufficiently smaller than q for correctness of decryption.

A party's secret key can be any secret allowing the party to generate secret vectors sᵢ∈Z_{q}ⁿ for every index i (or a subset of indices i). For example, as above, a party can use a nonce K and define sᵢ be a hash of K concatenated to the index i. Given this secret key, a vector of integers (x₁, . . . , xₖ) in Zₚ^{k} (for some integer p relatively prime to q) may be encrypted, for example, as follows.

A random vector a∈Z_{q}ⁿ may be selected together with error values (numbers) eᵢ∈Z_{q} chosen from the discrete Gaussian distribution with standard deviation σ. Using these error values, one can compute c₀:=a∈Z_{q}ⁿ and for every i∈n compute cᵢ:=(a, sᵢ)+peᵢ+xᵢ∈Z_{q}. The encryption of the data may be the vector c:=(c₀, c₁, . . . , cₙ).

Given the secret key, to issue a token for the weights (w₁, . . . , wₖ)∈Zₚ^{k} (e.g. allowing one to calculate the linear weighted sum Σᵢ₌₁^{k}wᵢwᵢ for encrypted data (x₁, . . . , xₖ)), token t :=Σᵢ₌₁^{k}wᵢsᵢ∈Z_{q}ⁿ may be given. Any party having an encryption c and a token t encrypted under the same key can calculate Σᵢ₌₁^{l}wᵢwᵢ, for example, as:

Σᵢ₌₁^{k}wᵢcᵢ−(a,t)=Σᵢ₌₁^{k}wᵢ·(a,sᵢ)+p·Σᵢ₌₁^{k}wᵢ·eᵢ+Σᵢ₌₁^{k}wᵢxᵢ−(a,Σᵢ₌₁^{k}wᵢsᵢ)=p·Σᵢ₌₁^{k}wᵢ·eᵢ+Σᵢ₌₁^{k}wᵢ^{x}ᵢ

from which Σᵢ₌₁^{k}wᵢxᵢ can be determined by computing the mod p operation. In other embodiments of the invention. the weights wᵢ may be selected from Z_{q} or other domains.

Here as well, the data (x₁, . . . , xₖ) may be decrypted and the tokens may be issued for weights (w₁, . . . , wₖ), or, equivalently, the weights (w₁, . . . , wₖ) may be encrypted and tokens may be issued for data (x₁, . . . , xₖ). For example, a data provider can encrypt his data and issue tokens for researchers, or a test provider can encrypt a test and issue tokens for using it on specific data.

In summary, a system, device, and method are provided for a token based obfuscation model where computations are obfuscated and data is transformed to a digital token which provides an encoding of the data and authorization for performing the computations on the data. The system can be implemented by a functional encryption scheme where the functional keys correspond to the obfuscated computations and the ciphertext (e.g. encryption) of a data corresponds to digital token for that data. Alternatively the functional keys correspond to the digital token for the data and the ciphertext correspond to obfuscated computations.

Embodiments of the invention may employ one master key to generate many functional keys for many tests and to generate tokens for many data items on which specific tests will be run, or may employ one master key per test and data pair. Embodiments of the invention may employ a variety of underlying functional key schemes including secret-key functional encryption schemes or bounded-key functional encryption schemes using public or secret keys.

Other token-based methods may be used, for example, as described in U.S. patent application Ser. No. 15/996,862, entitled “Device, System and Method for Token Based Outsourcing of Computer Programs,” the entirety of which is hereby incorporated by reference.

### Possible Configurations

The host of techniques provided according to embodiments of the invention could be implemented using a variety of different system configurations, for example, for use in a wide range of cases and a variety of different settings. A few examples are provided of different configurations and applications of embodiments of the invention. However, these examples are not meant to limit the scope of the invention, but rather to provide examples of some possible uses.

### Centralized Service

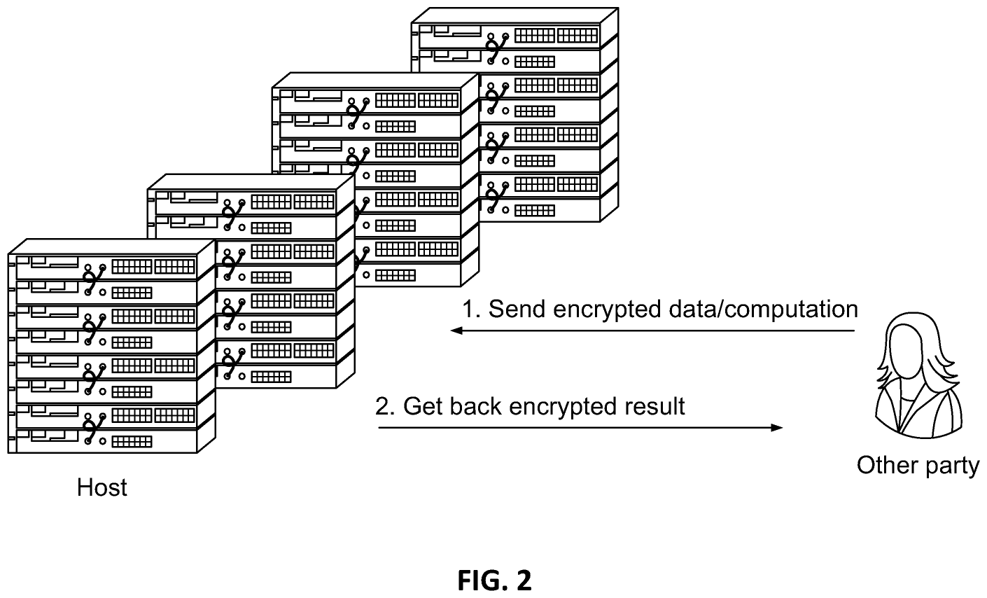

Reference is made to FIG. 2, which schematically illustrates a multi-party system comprising one or more data providers providing secret or private data to one or more centralized parties, according to an embodiment of the invention. In FIG. 2, a computation host may be configured as one or more centralized server(s) or part(ies), which may offer services to a variety of users, each taking the role of one of the parties mentioned above, such as, a data provider, care provider, test provider, data generator, researcher, and/or other trusted server.

Open public data: Some of the data stored by the computation host at the centralized server(s) may be public and can be accessed by anyone (or semi-public and accessed by a subset of users). For example, the list of all known genomic variants may be publicly available at the centralized computation host server.

Encrypted private user data: Private data that belongs to data providers (e.g. genomic data) may be stored in an encrypted form that cannot be accessed without proper permissions.

Backend server(s): The backend server(s) of the computation host may respond to user requests, verify permissions and, if necessary, access and process encrypted or public data. When encrypted data is processed, data evaluations may be executed homomorphically may the computation results may remain encrypted. All communication to the backend server(s) may be protected and secured by methods and protocols (e.g. SSL), and access to private data (even though the data is encrypted), may be allowed only with proper credentials.

Frontend user interface: The users (of all types of parties) may access the computational host via special software and/or hardware for performing operations and may send requests to the backend server(s). Once results are obtained from the computational host, the results may be displayed to the user, after decryption, in a user interface.

Secret key: Embodiments of the invention allows users to encrypt their private data, making it readable only using their secret key(s). These keys may be stored by the users themselves, accessible only to their local front-end interface, and may not be transmitted to any other party, including the computation host (which is honest-but-curious according to the model). The keys may be stored either by the user's interface software/hardware or local devices (e.g. smartphone, PC), or by a designated external secure hardware device (e.g. special USB drive).

This centralized architecture may provide a secure network of activity in which all the different parties can interact with and communicate data to each other without compromising security, storing their private data, and executing computations on the cloud.

It is noted that users of this service may not be limited to individual people (e.g. each possessing a single genome or set of medical data). Data providers, for example, may also include organizations which may possess hundreds or thousands of sequenced genomes (e.g. hospitals, universities, pharmaceutical companies, etc.). Outsourcing an organization's data to a specialized service may allow the organizations to transfer the responsibilities of private data management and security, and allow these parties to engage with other parties in various types of collaborations, without needing to trust each other. Instead of storing thousands of sequences on their own servers, these organizations may only need to manage their secret key(s). Assume, for instance, that a number of hospitals want to share their data and conduct some studies on a shared pool of information. Using such service, each of them may act as a separate data provider, so that they could collectively run a research use-case on their joint data, while ensuring that no malicious party is able to access their individual raw data.

Another embodiment of the invention may support a marketplace of genomic, biological and medical data. A research organization may run a test to search for genetic samples with certain genotypes and phenotypes for a study, without accessing the underlying genetic data. The research organization may then be charged a certain amount of money for any relevant genetic samples or information in order to obtain the appropriate keys to decrypt the data or test results. Data providers with relevant data (who can be either individuals or other organizations) may receive an offer to sell their data (e.g. giving all of it to the researcher, or letting it become a part of an aggregated result evaluated homomorphically, thus disclosing almost no information).

### On-Site Installation

In some embodiments, a data provider and a researcher may want to collaborate, e.g., to perform a study run by the researcher on the data provider's data. In some cases, the data provider and the researcher may not trust each other, and each may want to hide its secrets from the other (e.g. the data provider wants to conceal his data, and the researcher does not want anyone to know what she is testing for). For example, the research entity might be a pharmaceutical company looking to test hypotheses for drug development, and the data provider could be a hospital with a secure database of sequenced genomes.

According to some embodiments of the invention, the two parties may be able to collaborate as follows without revealing either party's sensitive information. One of the parties may host the computation, installing a computation host on its server(s) that can evaluate homomorphic calculations. The other party may then send its encrypted data or computations, which may be evaluated with the data or computation of the hosting party, and then the encrypted result may be sent to the other party, which will be able to decrypt the encrypted result using its key, and then display and read the decrypted result. If the result is intended for the hosting party, the hosting party will encrypt the result with another layer of encryption using its own key, and the other party will only remove its layer of encryption and send it to the host.

Embodiments of the invention allow either party to take either role, although typically the data provider is the host, as it has much more data that would otherwise have to be encrypted. In this case the researcher will send the data provider an encryption of her test (e.g. using the obfuscation techniques described herein). If, on the other hand, the researcher takes the role of the host, then the data provider will encrypt all of its data and send it to the researcher for evaluation on the researcher's own private computing environment.

Although this description focuses on a research use case, embodiments of the invention could also apply to other use cases (for example, a test provider collaborating with a data provider).

### Multiparty Collaboration

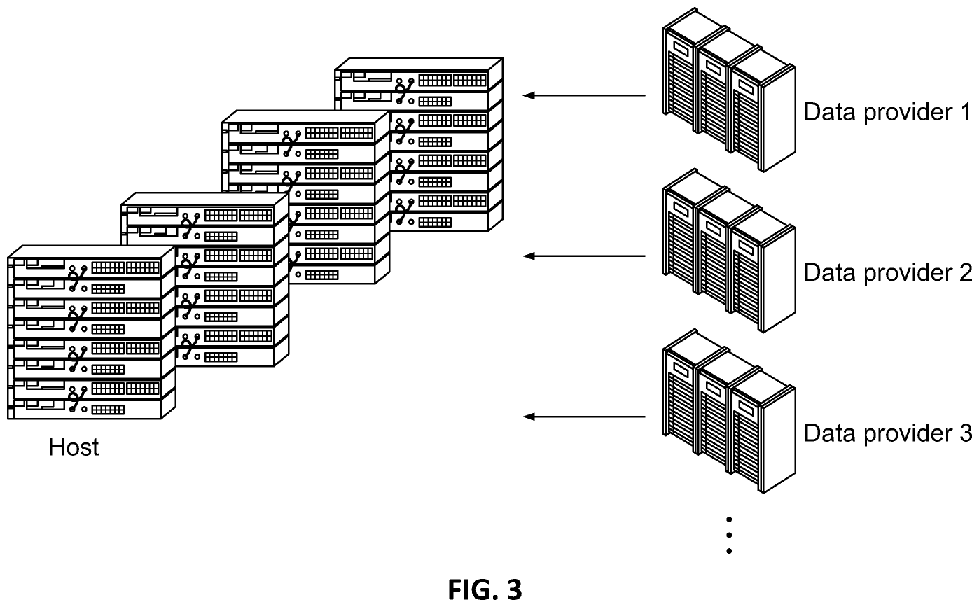

Reference is made to FIG. 3, which schematically illustrates a system implementing a collaboration among multiple data providers according to an embodiment of the invention. In FIG. 3, the system supports multiple data providers collaborating and executing a shared computation on an aggregation of both parties' private data. For example, multiple pharmaceutical companies (and other data providers such as hospitals and research institutions) may want to execute an extensive genomic study involving all of their aggregated data (e.g. they want to perform a large-scale GWAS).

In some cases, the data providers may not trust each other. To maintain data security, one of the parties (or an external party) may host the computations and initiate a computation host to evaluate computations homomorphically. The other parties may encrypt their data and send it to the host, which will then be able to homomorphically aggregate the data to obtain the computation result that can be decrypted by the relevant party(s).

The involved parties may encrypt their respective data with the same key (e.g. of a trusted third party) or use different keys (e.g. which will then require multi-party computations and multi-party decryption). In some embodiments, the data providers may not necessarily have to send their raw data. If, for example, the data providers calculate a shared contingency table, each of the data providers can create its own intermediate contingency table, using only its own data (e.g. and need not encrypt anything while calculating its own intermediate contingency table entries). Only after a party calculates its intermediate contingency table entries will the entries be encrypted and sent to the host. The host may then aggregate or merge each party's individual intermediate contingency table to form a combined contingency table (e.g. using addition operations).

### System Components

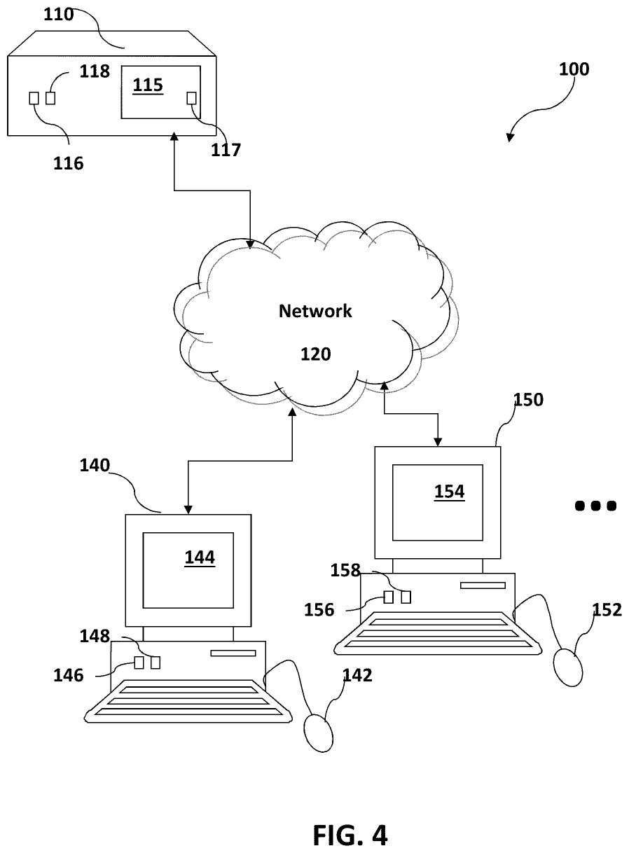

Reference is made to FIG. 4, which schematically illustrates a system 100 operating according to an embodiment of the invention. The systems described in reference to FIGS. 1, 2 and/or 3 may include devices and/or components of system 100 of FIG. 4. The devices of system 100 may be operated by one of the parties disclosed herein including, for example, a computation host, data provider, care provider, test provider, data generator, researcher, and/or other trusted server. In the example described below, server(s) 110 is operated by a computation host and computer(s) 140, 150, . . . are operated by respective data providers, though any other parties may operate these devices in accordance with other embodiments of the invention.

System 100 may include one or more computation host server(s) 110, an associated database 115, one or more computer(s) 140, 150, . . . of one or more data providers, all of which are connected via a network 120. Data provider computers 140 and 150 may each securely store unencrypted (or encrypted or) data and keys associated with each respective data provider.

Computation host server(s) 110 may include a computing device for hosting computations or tests on data encrypted by one or more keys according to embodiments disclosed herein. Computation host server(s) 110 may include applications for interacting with data provider computers 140 and 150.

Database 115 may include software processes or applications for storing and retrieving data 117 such as tests, functions or computations, encrypted data from data provider computers 140 and 150 (encrypted by single or multi-party keys), and/or encryption, decryption and/or re-encryption keys. Data 117 may also include code (e.g., software code) or logic, e.g., to enable the application of tests or computations on encrypted data, single, multi-party or PRE keys, or other data according to embodiments of the invention. Database 115 may be internal or external to one or more of the computation host server(s) 110 and may be connected thereto by a local or remote and a wired or wireless connection. In alternate embodiments, data 117 may be stored in an alternate location separate from database 115, e.g., memory unit(s) 118.

Data provider computers 140 and 150 may be servers, personal computers, desktop computers, mobile computers, laptop computers, and notebook computers or any other suitable device such as a cellular telephone, personal digital assistant (PDA), video game console, etc., and may include wired or wireless connections or modems. Data provider computers 140 and 150 may include one or more input devices 142 and 152, respectively, for receiving input from a user (e.g., via a pointing device, click-wheel or mouse, keys, touch screen, recorder/microphone, other input components). Data provider computers 140 and 150 may include one or more output devices 144 and 154 (e.g., a monitor or screen) for displaying data to a user provided by or for computation host server(s) 110.

Network 120, which connects computation host server(s) 110 and data provider computers 140 and 150, may be any public or private network such as the Internet. Access to network 120 may be through wire line, terrestrial wireless, satellite or other systems well known in the art.

Computation host server(s) 110 and data provider computers 140 and 150, may include one or more controller(s) or processor(s) 116, 146, and 156, respectively, for executing operations according to embodiments of the invention and one or more memory unit(s) 118, 148, and 158, respectively, for storing data (e.g., test computations, encryption, decryption or re-encryption keys, and encrypted, decrypted or re-encrypted data) and/or instructions (e.g., software for applying test computations or calculations, keys to encrypt, decrypt or re-encrypt data according to embodiments of the invention) executable by the processor(s). Processor(s) 116, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 148, and/or 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

### Use-Cases

Embodiments of the invention provide systems and methods for performing various use-cases, e.g. in the genomic field. These use-cases may be implemented using the elementary operations described herein. Some of the use-cases use a centralized configuration described in reference to FIG. 2, while other use-cases use decentralized, peer-to-peer, or other configurations.

### Clinical Tests

An individual's genomic, medical or biological data can be used to answer a medical question or retrieve relevant information about the individual's medical condition. Such tests may be used for diagnostic purposes (e.g. determining whether a patient has some disease or condition) or for treatment purposes (e.g. determining whether the patient's genome suggests a unique susceptibility to some drugs, hence requiring special dosing).

One type of clinical test is to check whether a patient has any “suspicious” values, for example known deleterious mutations. This could be done using the “test for specific value matches” operation. If the result is positive, often the patient's care provider (e.g. doctor or genetic counselor) will want to look at his entire genetic profile at the relevant genes, e.g. using the “lookup values” operation.

Other tests may involve the calculation of some score trying to estimate a medical condition (e.g. the probability of having a certain disease or condition). Calculations may be performed using elementary operations described herein (e.g. linear weighted sum, or an aggregate between scores) to improve system performance and efficiency. Calculations based on logistic regression, for example, may be reduced to a linear weighted sum. These calculations may be performed based on a combination of genomic data (e.g. variants), phenotypic data (e.g. weight), and/or other types of data. Not all the input data has to be confidential (e.g. encrypted).

Since exact score results may allow a curious recipient (e.g. the care provider) to reconstruct parts of the individual's genotype in some settings, to improve security, embodiments of the invention may round values or truncate the results to a limited precision (e.g. only two digits following the decimal point). In some embodiments, only a categorical result may be sent based on some determined thresholds (e.g. if the probability is less than 0.0001, output “negative” category; if between 0.0001 to 0.01, “low risk”; if between 0.01 to 0.1, “medium risk”; etc.).

### Direct-to-Consumer Reports

Some companies or organizations provide direct-to-consumer genetic reports. These reports are essentially a list of independent genetic and medical tests, similar to those used in clinics. These reports, however, are typically sent directly to a patient, not to the patient's care provider. These reports may disclose sensitive and secret personal information about the patient, allowing re-identification of the patient (because each report provides results for many independent tests, each test might be analyzing different genes).

Commercial companies offering such reports may be the test providers in this case. These companies may want to protect their algorithms and keep the details of their tests secret.

Matching Tests (for reproduction)

Some genetic tests estimate the risk that a couple's child will be born with a disease, genetic trait, or medical condition, based on the parents' genetic information. For example, if two parents are carriers of a recessive disease, a genetic test may determine the probability that their child would have the disease. In the case of recessive autosomal disease, the test may be for example: child risk=(mother_variant1 OR mother_variant2 OR . . . ) AND (father_variant1 OR father_variant2 OR . . . ), i.e. an AND aggregation over “test for specific value matches” tests run independently on each of the parents' genomes.

More generally, a matching test of parents may be an aggregation operator over independent tests conducted for each of the two parents. Such calculations may involve multiple keys, which may be addressed by using either multi-party computation or Proxy Re-Encryption.

Matching tests may be important in the case of testing conducted at sperm banks. When a forthcoming mother chooses the best sperm donor for her child, she may want to test for mutual genetic risks against each of the pool of sperm donor candidates. Embodiments of the invention allow the mother to have the final genetic test results, while hiding the sperm donor's genetic information, thereby preserving the privacy of the candidate donors.

### Ancestry Tests

Some people are curious to learn about their ethnicity and family history. There are various tests that estimate the likelihood a person belongs to various ethnicities. These tests may sometimes be calculated as linear weighted scores, which can be homomorphically evaluated efficiently according to embodiments of the invention. For example, a score associated with East European ethnicity may be a linear weighted sum of some variants indicative of this origin.

### Relativity Tests

Relativity tests usually rely on defining a metric between pairs of genomes. Exact calculation of the distance may use a computation over all the variants in the genomes, but in practice sufficient accuracy may be obtained by computing over only at a small subset of the variants (as long as specific key variants are selected).

In order to compute relativity tests fast and efficiently, the computation host can pre-select a fixed set of variants (e.g. SNPs) that will be used to compute a “distance” or difference between every pair of individuals, thus allowing to store these values in a cache or local memory for quick e.g. SIMD computations. The computation in this case may be a point-wise comparison of the relevant genomic values, followed by a measure of the number of matches.

Examples for relativity tests include a paternity test (one-to-one) and relative findings (one-to-many).

### Research

Embodiments of the invention may be used not only to protect data providers from security breaches, but also to encourage data providers to share their data e.g. to advance human knowledge. Research organizations (including enterprises), may want to conduct studies on encrypted data stored in the computation host. In the case of a centralized service, many data providers (as many as could be considered in a study e.g. hundreds or thousands) may receive an offer to participate. To give their consent to participate in the study, the data providers may send their appropriate re-encryption keys.

The most common type of genetic studies is typically association studies, which can be supported by providing the researcher with the relevant contingency tables (e.g. using the “create contingency table” operation). Once the researcher has the data summarized in these contingency tables, in some embodiments, she can complete the statistical analysis in cleartext. Such embodiment may provide sufficient security in some cases; however, in other cases, this might allow re-identification of certain individuals participating in the study, especially when very rare genotypes or phenotypes are involved.

There are multiple ways to overcome this issue. First, some embodiments of the invention may delegate the task of the statistical analysis to a trusted server other than the research organization, e.g.: a server owned or operated by the same owners of the computation host or any other reputable organization, who will provide the researcher only with the final statistical conclusion (e.g. significant or not, or truncated p-value and odds-ratio values). Alternatively, the computation host may execute the statistical analysis homomorphically, and even truncate the results, though such computations would generally be computationally expensive. Another solution is to give the researcher the raw contingency tables, but only after validating (e.g. homomorphically) that all the sums of all the rows and columns in the table are above a certain threshold, as low-valued rows and columns are typically most vulnerable to re-identification.

A permissive approach for any research use-cases may be to provide the researcher with all the raw data of the individuals involved in the study (using the “lookup values” operation). If a study only looks at a very limited number of values (e.g. a common variant against a common phenotype), this may provide sufficient security. Such embodiments may allow the researcher to conduct any possible analysis, and could be especially useful where continuous numerical variables (rather than categorical variables) are involved.

### Overview

Embodiments of the invention include a system and method for providing a sparse and efficient data representation, where each entry defines an allele (or other genetic or medical information) by a binary state (0 or 1) and only the binary information (0 or 1) is encrypted. In various embodiments, such data representations may be used to represent genomic data, phenotypic data, or a combination of genomic and phenotypic data.

Embodiments of the invention include a system and method for computing on plaintexts represented as above.

Embodiments of the invention include a system and method for representing genomic data in the sparse data representation described herein, providing AES encryption to the sparse data representation, converting the AES encrypted data to FHE encrypted data, where rather than representing the encrypted data by 1 bit per ciphertext, the FHE encrypted data may be represented by many bits packed into an FHE ciphertext.

Embodiments of the invention include a system and method for applying proxy re-encryption in the context of genomic ciphertexts.

Embodiments of the invention include a system and method for encrypting alleles (or variants) for which a test is searching for one or more target or query alleles, and comparing those target or query alleles (or variants) to encrypted alleles (or variants) corresponding to those present in a patient's secret genome, for example, by applying an Eval operation on two fully encrypted genomic sequences (e.g., as performed in the search operation 121 of FIG. 1).

Instead of encrypting data representing an individual's alleles, embodiments of the invention include a system and method for encrypting a binary representation (0 or 1) thereof as the sparse data representation. Embodiments of the invention include a system and method, in which a client may automatically permute the locations of the alleles (or data representations thereof) at random using an injective mapping (e.g., operation 103 of FIG. 1), and only encrypts the binary representation (0 or 1) thereof (e.g., operation 107 of FIG. 1), keeping the pseudo random permutation secret, but may share it with the test provider when a test on the data is to be performed. The test provider may permute the test-alleles using the same pseudo random permutation (e.g., operation 113 of FIG. 1) and may provide both the data and test to the computation host.

Embodiments of the invention include a system and method for using multi-key FHE encryption to encrypt both tests (computations, calculations and genetic indices or data operated over) and the data being tested.

Embodiments of the invention include a system and method for using proxy re-encryption for converting the multiple different keys initially encrypting both tests and data into a new common key.

Embodiments of the invention include a system and method for executing the following operations for each computation: encrypt the computation, perform the computation of FHE ciphertexts. Some embodiments include computations that provide string comparison to detect differences between the presence of genomic sequences.

Embodiments of the invention include a system and method for providing a token based model where tokens correspond to data. In some embodiments, a secret key FE: where the keys correspond to a program and the ciphertext represents the genomic data. In some embodiments, such a representation may be used to encrypt and test genomic data. In some embodiments, one master key may be used to generate many slave keys for conducting many tests and generating tokens for data on which specific tests are to be run. Embodiments of the invention may use a Functional Encryption (FE) cryptosystems, for example, one which enables releasing many functional-keys without compromising security. The number of functional keys released may be pre-determined, for example, at the time of setup or at other times.

Embodiments of the invention include a system and method in which the roles of data and test in the above description are switched. A data owner may generate one or more functional keys which correspond to his data (and for which he possesses the master key. When a test is to be executed, the owner may generate ciphertexts which serve as tokens and correspond to the test to be run on the data. In some embodiments, the test may be “blinded” (encrypted or obfuscated) to protect it from being revealed to the data owner. Such embodiments may be executed using a multi-party computation technique, such as, proxy re-encryption.

Embodiments of the invention include a system and method for Palliel based token based models for linear functions. Such models may be applied to encrypt genomic data.

Embodiments of the invention include a system and method for LWE based token based models for linear functions. Such models may be applied to encrypt genomic data.

### CONCLUSION

In the foregoing description, various aspects of the present invention are described. For purposes of explanation, specific configurations and details are set forth in order to provide a thorough understanding of the present invention. However, it will also be apparent to one of ordinary skill in the art that the present invention may be practiced without the specific details presented herein. Furthermore, well known features may be omitted or simplified in order not to obscure the present invention.

Unless specifically stated otherwise, as apparent from the foregoing discussion, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

It should be recognized that embodiments of the present invention may solve one or more of the objectives and/or challenges described in the background, and that embodiments of the invention need not meet every one of the above objectives and/or challenges to come within the scope of the present invention. While certain features of the invention have been particularly illustrated and described herein, many modifications, substitutions, changes, and equivalents may occur to those of ordinary skill in the art. It is, therefore, to be understood that the appended claims are intended to cover all such modifications and changes in form and details as fall within the true spirit of the invention.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. An encryption system for generating an efficiently searchable encryption of secret data, the system comprising:
one or more memories configured to store unencrypted secret data and a homomorphic encryption key; and
one or more processors configured to:
transform the unencrypted secret data into encoded secret data using an injective encoding such that each distinct value of the unencrypted secret data is mapped to a unique index in the encoded secret data,
homomorphically encrypt the encoded secret data using the homomorphic encryption key to generate one or more secret data ciphertexts, wherein the homomorphic encryption key preserves the indexing of the injective encoding of the secret data, and
transmit the one or more secret data ciphertexts to an external system for searching the secret data ciphertexts for one or more encoded queries, wherein the one or more encoded queries are encoded by the same injective encoding as the secret data, to directly search only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts.

2. The system of claim 1, wherein the one or more encoded queries are unencrypted or query ciphertexts encrypted by the same homomorphic encryption key used to encrypt the secret data ciphertexts.

3. The system of claim 1, wherein only the one or more query indices are selectively searched and not the remaining indices of the secret data ciphertexts by homomorphically operating on the values of the secret data ciphertexts by non-zero query values only at the one or more query indices and zero query values at all remaining indices.

4. The system of claim 3, wherein the homomorphic operation is an inner product of the one or more pairwise values of the of the encoded queries and secret data ciphertexts.

5. The system of claim 4, wherein a match is detected when the homomorphic computation is non-zero and a mismatch is detected when the homomorphic operation is zero.

6. The system of claim 5, wherein computing a zero value indicates no match, computing a first value indicates a single match, and computing a multiple m of the first value indicates a plurality of m matches between values of the queries and secret data ciphertexts.

7. The system of claim 1, wherein the unencrypted secret data includes a plurality of N datasets each associated with a plurality of M_{N} values and is represented by a double-linked list comprising an outer list representing the N datasets and an inner list representing the M_{N} values associated with each dataset, a matrix of dimensions greater than or equal to N×maximum M_{N}, or vectors of cumulative length greater than or equal to Σ_{n∈N}n·Mₙ.

8. The system of claim 7, comprising segmenting the encoded secret data, wherein at least two of the N datasets have different numbers of values M_{N}, and the segments are divided into fixed lengths, resulting in a plurality of encoded secret data segments that have a combination of data from multiple of the N datasets.

9. A search system for efficiently searching an encrypted secret data ciphertext, the search system comprising:
one or more memories configured to store one or more queries; and
one or more processors configured to:
transform the queries into one or more encoded queries using an injective encoding such that each distinct value of the unencrypted queries is mapped to a unique index in the one or more encoded queries,
receive, from an external encryption system, one or more secret data ciphertexts that represent a homomorphic encryption of secret data using a homomorphic encryption key, wherein the secret data ciphertexts are encoded by the same injective encoding as the one or more encoded queries, and
search the secret data ciphertexts for the one or more encoded queries by directly searching only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts.

10. The system of claim 9, wherein the one or more processors are configured to encrypt the queries by the same homomorphic encryption key used to encrypt the secret data ciphertexts or search with unencrypted queries.

11. The system of claim 9, wherein the one or more processors are configured to selectively search only the one or more query indices and not the remaining indices of the secret data ciphertexts by homomorphically operating on the values of the secret data ciphertexts by non-zero query values only at the one or more query indices and zero query values at all remaining indices.

12. The system of claim 11, wherein the one or more processors are configured to operate by homomorphically computing an inner product of the one or more pairwise values of the of the encoded queries and secret data ciphertexts.

13. The system of claim 12, wherein the one or more processors are configured to detect a match when the homomorphic computation is non-zero and detect a mismatch when the homomorphic operation is zero.

14. A method for generating an efficiently searchable encryption of secret data, the method comprising:
storing unencrypted secret data and a homomorphic encryption key;
transforming the unencrypted secret data into encoded secret data using an injective encoding such that each distinct value of the unencrypted secret data is mapped to a unique index in the encoded secret data,
homomorphically encrypting the encoded secret data using the homomorphic encryption key to generate one or more secret data ciphertexts, wherein the homomorphic encryption key preserves the indexing of the injective encoding of the secret data, and
transmitting the one or more secret data ciphertexts to an external system for searching the secret data ciphertexts for one or more encoded queries, wherein the one or more encoded queries are encoded by the same injective encoding as the secret data, to directly search only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts.

15. The method of claim 14, wherein the one or more encoded queries are unencrypted or query ciphertexts encrypted by the same homomorphic encryption key used to encrypt the secret data ciphertexts.

16. The method of claim 14, wherein only the one or more query indices are selectively searched and not the remaining indices of the secret data ciphertexts by homomorphically operating on the values of the secret data ciphertexts by non-zero query values only at the one or more query indices and zero query values at all remaining indices.

17. The method of claim 16, wherein the homomorphic operation is an inner product of the one or more pairwise values of the of the encoded queries and secret data ciphertexts.

18. The method of claim 17, wherein a match is detected when the homomorphic computation is non-zero and a mismatch is detected when the homomorphic operation is zero.

19. The method of claim 18, wherein computing a zero value indicates no match, computing a first value indicates a single match, and computing a multiple m of the first value indicates a plurality of m matches between values of the queries and secret data ciphertexts.

20. The method of claim 14, wherein the unencrypted secret data includes a plurality of N datasets each associated with a plurality of M_{N} values and is represented by a double-linked list comprising an outer list representing the N datasets and an inner list representing the M_{N} values associated with each dataset, a matrix of dimensions greater than or equal to N×maximum M_{N}, or vectors of cumulative length greater than or equal to Σ_{n∈N}n·Mₙ.

21. The method of claim 20, comprising segmenting the encoded secret data, wherein at least two of the N datasets have different numbers of values M_{N}, and the segments are divided into fixed lengths, resulting in a plurality of encoded secret data segments that have a combination of data from multiple of the N datasets.

22. A method for efficiently searching an encrypted secret data ciphertext, the method comprising:
storing one or more queries;
transforming the queries into one or more encoded queries using an injective encoding such that each distinct value of the unencrypted queries is mapped to a unique index in the one or more encoded queries;
receiving, from an external encryption system, one or more secret data ciphertexts that represent a homomorphic encryption of secret data using a homomorphic encryption key, wherein the secret data ciphertexts are encoded by the same injective encoding as the one or more encoded queries; and
searching the secret data ciphertexts for the one or more encoded queries by directly searching only one or more indices of the secret data ciphertexts corresponding to one or more query indices having non-zero query values, to detect if one or more values of the secret data ciphertexts match one or more values of the encoded queries at the one or more query indices, without searching the remaining indices of the secret data ciphertexts.

23. The method of claim 22 comprising encrypting the queries by the same homomorphic encryption key used to encrypt the secret data ciphertexts or searching with unencrypted queries.

24. The method of claim 22 comprising selectively searching only the one or more query indices and not the remaining indices of the secret data ciphertexts by homomorphically operating on the values of the secret data ciphertexts by non-zero query values only at the one or more query indices and zero query values at all remaining indices.

25. The method of claim 24 comprising operating by homomorphically computing an inner product of the one or more pairwise values of the of the encoded queries and secret data ciphertexts.

26. The method of claim 25 comprising detecting a match when the homomorphic computation is non-zero and detecting a mismatch when the homomorphic operation is zero.
